(19) United States
(12) Patent Application Publication
(10) Pub. No.: US 2007/0162343 A1
(43) Pub. Date: Jul. 12, 2007

(54) Serious intent mechanism and method

(75) Inventor: Mark Landesmann, San Francisco, CA (US)

Correspondence Address: FOLEY AND LARDNER LLP;SUITE 500, 3000 K STREET NW, WASHINGTON, DC, 20007, US

(73) Assignee: BUYERLEVERAGE

(21) Appl. No.: 11/714,215

(22) Filed: Mar. 6, 2007

Related U.S. Application Data
(63) Continuation of application No. 09/862,420, filed on May 23, 2001.
Application No. 09/862,420 is a continuation of application No. 09/758,239, filed on Jan. 12, 2001.
(60) Provisional application No. 60/243,960, filed on Oct. 30, 2000.
(60) Provisional application No. 60/243,960, filed on Oct. 30, 2000.

(51) Int. Cl. G06Q 30/00

(52) U.S. Cl. 705/14

(57) ABSTRACT

A method and system for determining a serious intent to purchase a good or service, comprising the steps of: receiving a declaration of intent to purchase a good or service from a buyer entity and not receiving at substantially the same time a commitment to purchase that good or service from a specific selling entity; receiving a penalty deposit of value or a penalty authorization to obtain something of value from the buyer entity to facilitate future payment of a penalty; determining if a proof of purchase of the good or service has been received within a predetermined period of time; if the proof of purchase has been received within the predetermined period of time, then returning the deposit or canceling the authorization.

### CROSS-REFERENCE TO RELATED APPLICATIONS

This application is a Continuation of U.S. application Ser. No. 09/862,420, filed on May 23, 2001, incorporated herein by reference in its entirety, which is a Continuation of U.S. application Ser. No. 09/758,239, filed on Jan. 12, 2001, incorporated herein by reference in its entirety, which claims priority from Provisional Application U.S. Ser. No. 60/243,960, filed on Oct. 30, 2000, incorporated herein by reference in its entirety. Application Ser. No. 09/862,420 filed May 23, 2001 also claims priority under 35 U.S.C. 119(e) of Provisional Application No. 60/243,960 filed on Oct. 30, 2000.

### FIELD OF THE INVENTION

The present invention relates generally to the field of marketing, and more particularly to the field of interactive communications with buyer entities.

### BACKGROUND OF THE INVENTION

In the U.S. alone, marketers spend more than $230 billion per year on advertisements to acquire new customers (source: McCann-Erickson). Many of these advertisements are not relevant to the immediate purchase interests of consumers. For instance, most people living in the United States have seen many advertisements for cars the vast majority of which were seen at a time that they had no immediate interest in purchasing an automobile. The wastefulness of mass advertising not only hurts businesses, it also clutters the day to day life of many consumers: Some studies have estimated that Americans are exposed to as many as 3000 advertising messages per day (source: Michael J. Wolf, The Entertainment Economy and Jupiter Communications).

Marketers attempt to reach consumers precisely at the time that they are considering new purchases but have few and precious means of doing so. The consumption of most advertising media reveals very little about a consumers precise purchase interests. For instance, a viewer who watches the NBC Television show “Friends” might be interested in purchasing or consuming similar entertainment products in the future, and he might be more likely to belong to certain demographic groups than others, but it is difficult to make further inferences about his specific purchase interests: whether he is currently looking to buy new furniture for his apartment, or a new car, a new suit or a new television.

An exception are publications and web sites specifically dedicated to informing consumers about certain products and services. A person visiting the web site Autobytel.com is likely to be interested in purchasing a car, and the specific web pages he visits are likely to be indicative of the type of car he is looking to buy. However, his browsing behavior does not necessarily reveal if he seriously intends to buy a car, or if he is just a curious shopper with a comparatively low likelihood of making a car purchase in the near future. Advertisers can try to reach him with a banner ad on the site, but the click thru rate on banner ads is less than one in a thousand (source: Business Week, March 2001). To get his sustained and undivided attention, an advertiser might want to place an offer which promises a lucrative reward to that person for viewing an advertisement. However, if such a reward is attractive enough to be interesting to many car buyers, it will also attract opportunity seekers to the site who have no or very little interest in buying a car, and who came solely or mainly to collect the reward for viewing the advertisement. This would drain the advertiser's resources without increasing the advertiser's revenues. (Even in the absence of such a reward, there are other reasons that someone would pretend an interest in buying a product for which he does not truly intend to buy: For instance, someone might want to test drive the latest luxury sports car, without being able to afford buying it.)

Similarly to the special reward, a car seller might want to offer a special level of sales service to those who identify themselves as potential car buyers, either by making salespeople available on the phone to answer questions or by inviting potential consumers to visit dealerships where they will receive a higher than usual level of attention and service. However, online as well as offline, it is generally very difficult to distinguish between serious and less serious buyers, and companies cannot afford to offer to everyone the high level of service that they would want to give someone who seriously intends to make a purchase.

Salespeople are therefore trained to distinguish between serious and less serious buyers as early as possible in the sales process, but this is a time consuming, difficult and often erroneous process.

### SUMMARY OF THE INVENTION

Briefly, the present invention comprises, a method for determining a serious intent to purchase a good or service, comprising the steps of: receiving a declaration of intent to purchase a good or service from a buyer entity and not receiving at substantially the same time a commitment to purchase that good or service from a specific selling entity; receiving a penalty deposit of value or a penalty authorization to obtain something of value from the buyer entity to facilitate future payment of a penalty; determining if a proof of purchase of the good or service has been received within a predetermined period of time; if the proof of purchase has been received within the predetermined period of time, then returning the deposit or canceling the authorization.

In a further aspect of the present invention, the step is included of: providing an offer to provide at least one benefit to a buyer entity relating to its aforementioned intended purchase.

In a further aspect of the present invention, the step is included of providing the at least one benefit to the buyer entity prior to receipt of the proof of purchase.

In a further aspect of the present invention, the good or service is determined to be in a category; and wherein the providing an offer with a benefit step comprises selecting at least one benefit that is correlated to the category of good or service.

In a further aspect of the present invention, the step is included of providing the benefit to the buyer entity only if the proof of purchase has been received.

In a further aspect of the present invention, the good or service is determined to be in a category; and wherein the providing an offer with a benefit step comprises selecting at least one benefit that is correlated to the category of good or service.

In a further aspect of the present invention, the receiving proof of purchase step comprises linking to a third party database and obtaining information there from on whether the buyer entity made a purchase of the good or service in the declaration.

In a further aspect of the present invention, the proof that the purchase was made comprises receiving proof of purchase records created by a third party source; and further comprising the step of comparing the third party source of the proof of purchase records with a source database of third party sources and entering only those proof of purchase records if from third party sources that are in the source database.

In a further aspect of the present invention, the providing at least one benefit step comprises the steps of sending a communication including a serious intent rating to a third party; and receiving an identification of the at least one benefit from the third party.

In a further aspect of the present invention, the providing the at least one benefit step comprises directly providing the at least one benefit to the buyer entity.

In a further aspect of the present invention, the facilitating the provision of the at least one benefit step comprises sending a third party a communication to initiate the provision of the benefit by the third party.

In a further aspect of the present invention, the step id provided of searching a database to obtain a serious intent rating for the buyer entity.

In a further aspect of the present invention, the benefit and penalty comprise crediting and/or debiting an account.

In a further aspect of the present invention, the providing an offer to provide at least one benefit step comprises the steps of: obtaining at least one threshold serious intent rating for the intended purchase; comparing the threshold serious intent rating to a serious intent ratings of the buyer entity; and selecting the at least one benefit based on a result of the comparison.

In a further aspect of the present invention, step are included of: obtaining at least one threshold serious intent rating for the intended purchase to be made by the buyer entity as well as a serious intent rating for the buyer entity; comparing the threshold serious intent rating to the serious intent rating of the buyer entity; and selecting penalty based on a result of this comparison.

In a further aspect of the present invention, the benefit comprises a set of benefits, with at least one of the set of benefits having a reward associated with its selection that is to be paid to the buyer entity.

In a further aspect of the present invention, the step is included of obtaining a serious intent rating for the buyer entity; and generating a charge to an advertiser providing the at least one benefit as a function of the serious intent rating of the buyer entity receiving the benefit.

In a further aspect of the present invention, the steps are included of: determining an income level for the buyer entity; comparing the income level of the buyer entity to a threshold income level and only offering at least one of the benefits if the buyer entity income level exceeds the threshold income level.

In a further aspect of the present invention, the receiving a declaration of intent step comprises receiving a designation of one from a set of levels of intent from the buyer entity; and further comprising the step of determining the benefit by selecting at least one benefit based on this designated level of intent.

In a further aspect of the present invention, the step are included of calculating a serious intent rating of a buyer entity based on the factors of the number of times the buyer entity has declared that it would purchase a product or service, and the number of times that proof that the product or service was purchased was received for the buyer entity within a predetermined time period; and using that serious intent rating to select at least one benefit to be offered to the buyer entity.

In a further aspect of the present invention, the step of calculating the serious intent rating of a buyer entity also includes as part of the calculation the factors of the total amount of money that the buyer entity has spent for the product or service over a predetermined time period, and the total amount of money for the products and/or services that the buyer entity has declared a serious intent to purchase.

In a further aspect of the present invention, the serious intent rating is partly calculated by multiplying the number of times the buyer entity has declared that it will purchase a product or service by the percentage of times that the proof of purchase for the buyer entity related to the declaration of serious intent has been submitted within the predetermined time period, and partly calculated by multiplying the total amount of money spent in relation to serious intent declarations by the total amount of money for the product and/or services for which the buyer entity has made serious intent declarations.

In a further aspect of the present invention, the steps are included of determining a category for the goods or services designated in the intent to purchase from a set of categories; wherein the obtaining a serious intent rating step comprises determining a serious intent rating for the buyer entity in the determined category of goods or services; and selecting benefits from different vendors selling the designated goods or services in the determined category.

In a further aspect of the present invention, the step are included of calculating a class serious intent rating for a particular buyer entity in accordance with a function of separate serious intent ratings of a plurality of selected categories for the particular buyer entity; and wherein the providing at least one benefit step comprises selecting one benefit based on the class serious intent rating.

In a further aspect of the present invention, the steps are included of: receiving buyer entity preferences for particular benefits; wherein the providing an offer to provide at least one benefit step comprises selecting a group of benefits for presentation to the buyer entity, based at least in part, on the buyer entity preferences.

In a further aspect of the present invention, the steps are included of: receiving a threshold value from the buyer entity that the benefits must meet before the buyer entity will receive the benefit; and wherein the providing an offer step comprises providing only benefits that meet or exceed the threshold value.

In a further aspect of the present invention, the providing an offer step comprises providing a plurality of the benefits from different advertisers to the buyer entity, including the step of determining the sequence or the relative prominence of each of the plurality of the benefits based on the serious intent rating.

In a further aspect of the present invention, the steps are included of obtaining non-purchase information about the buyer entity from a third party; and searching the non-purchase information to obtain at least one attribute about the buyer entity; correlating that attribute to a benefit from among a plurality of benefits based on the correlated attribute; and wherein the providing an offer to provide at least one benefit step comprises presenting or facilitating the presentation of the correlated benefit to the buyer entity.

In a further aspect of the present invention, the providing an offer of at least one benefit step further comprises the step of selecting one of the benefits based on a serious intent rating of the buyer entity; and further comprising sending the serious intent rating of the buyer entity to a third party after receipt of an authorization from the buyer entity.

In a further aspect of the present invention, the providing an offer of at least one benefit step further comprises the step of selecting one of the benefits based on a serious intent rating of the buyer entity; and further comprising storing electronically the serious intent rating for the buyer entity at a computer of the buyer entity.

In a further aspect of the present invention, the storing step comprises storing the serious intent rating on a cookie.

In a further aspect of the present invention, the step is included of the buyer entity sending the serious intent rating to a third party.

In a further aspect of the present invention, the providing an offer of at least one benefit step further comprises the step of selecting one of the benefits based on a serious intent rating of the buyer entity, wherein the selecting step includes comparing the serious intent rating of the buyer entity to a set of threshold levels, with a different predetermined benefit associated with exceeding each different threshold level in the set of threshold levels; and selecting the benefit associated with the highest threshold level exceeded by the serious intent rating.

In a further aspect of the present invention, the determining if a proof of purchase has been received step comprises linking to a third party database and obtaining information there from on whether the buyer entity made a purchase of the good or services in the declaration and inputting this information to a database.

In a further aspect of the present invention, the determining if a proof of purchase has been received step comprises receiving proof of purchase records created by a third party source; and further comprising the step of comparing the third party source of the proof of purchase records with a source database of third party sources and entering only those proof of purchase records if from third party sources that are in the source database.

In a further aspect of the present invention, the providing an offer of at least one benefit step further comprises the step of selecting one of the benefits based on a serious intent rating of the buyer entity; and further comprising the steps of: storing the serious intent rating for the buyer entity on a cookie at a computer of the buyer entity; a merchant accessing the cookie and obtaining the serious intent rating; the merchant correlating the accessed serious intent rating to at least one item of content; and serving to the buyer entity the at least one item of content.

In a further aspect of the present invention, the providing an offer of at least one benefit step further comprises the step of selecting one of the benefits based on a serious intent rating of the buyer entity; and further comprising the steps of storing the serious intent rating for a buyer entity on a cookie at a computer of the buyer entity; and updating the serious intent rating on the cookie with a recalculated serious intent rating.

In a further aspect of the present invention, the steps are included of monitoring the receipt of video to determine if an ad has been zapped; and providing a benefit to the buyer entity if the ad has not been zapped.

In a further aspect of the present invention, the steps are provided of: monitoring the receipt of video to determine if an ad has not been zapped; if the ad has not been zapped, then determining a benefit to be offered to the buyer entity based on a serious intent rating of the buyer entity.

In a further aspect of the present invention, the buyer entity is determined based on receipt of an ID from the buyer entity.

In a further aspect of the present invention, the buyer entity is determined based on a registration of a receiver for the video.

In a further aspect of the present invention, the receiving a declaration of intent step further comprises, asking the buyer entity at least one question relating to the buyer entity's intent; obtaining at least one answer to the at least one question from the buyer entity; and further comprising calculating or adjusting a serious intent rating on the basis of the at least one answer; and using the serious intent rating to select benefits to be offered to the buyer entity.

In a further aspect of the present invention, the calculating or adjusting the serious intent rating step further comprises, correlating the at least one answer of the buyer entity to the incidence by which members of a comparison group comprising other buyer entities who have given the same or similar answer relative to the at least one answer when making the same or a similar declaration of intent have made a purchase conforming with or relating to the declaration of intent; and calculating or adjusting the serious intent rating based on the correlation.

In a further aspect of the present invention, the incidence is derived in whole or in part by comparing the number of members of the comparison group who have submitted the proof of purchase with the number of members of the comparison group who have not submitted the proof of purchase.

In a further aspect of the present invention, the comparison group comprises only other buyer entities that have submitted declarations of intent to purchase a good or service in a same category as the good or service in the declaration of intent.

In a further aspect of the present invention, members of the comparison group are selected to include members with demographic attributes that are similar to the demographic attributes of the buyer entity.

In a further aspect of the present invention, the steps are provided of: adjusting a value of the serious intent rating for the buyer entity based on receipt of the proof that the purchase was made; and wherein the receiving a declaration of intent step comprises receiving a designation of one from a set of levels of intent from the buyer entity; and wherein the providing an offer step to provide at least one benefit step comprises selecting at least one benefit based on this designated level of intent.

In a further aspect of the present invention, the adjusting the value of the serious intent rating step comprises also adjusting the value of the serious intent rating for the buyer entity based on the designated level of intent.

In a further aspect of the present invention, the providing an offer of at least one benefit step further comprises the step of selecting one of the benefits based on a serious intent rating of the buyer entity, wherein the serious intent rating is used as a variable in a mathematical formula to calculate the benefit.

In a further aspect of the present invention, the receiving a declaration of intent step comprises receiving a declaration of intent from a buyer entity in which the buyer entity declares its intent to discontinue purchasing a product or service from a selling entity from which it has previously purchased the product or service; and using that intent to discontinue information.

In a further aspect of the present invention, the receiving a declaration of intent step further comprises receiving from a buyer entity proof of purchase information which indicates the buyer entity's past level of spending on the product or service.

In a further aspect of the present invention, the using step comprises using the intent to discontinue information to determine the at least one benefit.

In a further aspect of the present invention, the step is included of providing an offer of at least one benefit by selecting the benefit based on a serious intent rating of the buyer entity; and wherein the using step comprises using the intent to discontinue information to recalculate the serious intent rating.

In a further aspect of the present invention, the using step comprises designating the buyer entity so that it may be accessed by a search on intent to discontinue declarations.

In a further aspect of the present invention, the receiving a declaration of intent step comprises receiving a declaration of intent from a buyer entity in which it declares its intent to discontinue purchasing a product or service from a first selling entity from which it has previously purchased the product or service on a regular basis; and wherein the returning the deposit or canceling the authorization step is contingent upon the proof of purchase showing that the buyer entity has purchased the product or service from a second selling entity which is different from the first selling entity after submitting its declaration of intent.

In a further aspect of the present invention, the receiving a declaration of intent step further comprises receiving a proof of purchase from a buyer entity which indicates its past level of spending on the product or service.

In a further aspect of the present invention, the receiving a declaration of intent step contains a declaration of the buyer entity's intent or willingness to purchase at least a specified volume of a product or service or of a category of products or services from a single selling entity over a specified time period, and wherein the determining if a proof of purchase has been received comprises receiving a proof that an amount equal or higher then the specified volume was purchased by the buyer entity over the specified time period.

In a further embodiment of the present invention, a system is provided for determining a serious intent to purchase a good or service, comprising: a component for receiving a declaration of intent to purchase a good or service from a buyer entity and not receiving at substantially the same time a commitment to purchase that good or service from a specific selling entity; a component for receiving a penalty deposit of value or a penalty authorization to obtain something of value from the buyer entity to facilitate future payment of a penalty; a component for determining if a proof of purchase of said good or service has been received within a predetermined period of time; and a component for, if the proof of purchase has been received within the predetermined period of time, returning the deposit or canceling the authorization.

In yet a further aspect of the present invention, the inventive system may include one or more components to perform the various other method steps disclosed herein.

### BRIEF DESCRIPTION OF THE DRAWINGS

FIG. 1 is a schematic block diagram of one embodiment of the overall system of the present invention.

FIG. 2 is a schematic block diagram of a flow chart for the method and system of the present invention.

FIG. 3 is a schematic block diagram of one or more of the operations of FIG. 2.

FIG. 4 is a schematic block diagram of the system and method of a further embodiment of the present invention.

FIG. 5 is a schematic block diagram of the system and method for a yet further embodiment of the present invention.

FIG. 6 is a schematic block diagram of a yet further embodiment of the system and method of the present invention.

### DETAILED DESCRIPTION OF THE PREFERRED EMBODIMENTS

It is an object of one embodiment of the present invention to help sellers identify those buyers who have a serious intent of making a purchase and to distinguish them from other buyers. This, for the purpose of competing more effectively for the business of these buyers. More specifically, the invention allows sellers and marketers to direct resources and benefits at serious buyers, which are designed to influence them and to educate them about the benefits of their products, at the time that these buyers are in the process of making a decision on the particular product or brand they wish to purchase. Sellers will offer, among other things, (1) a higher level of service to buyers with a high degree of intent to buy their product (these buyers are hereafter referred to as “serious buyers”), and (2) special rewards to serious buyers for spending time considering and educating themselves about their products.

At the same time, the invention allows serious buyers to identify themselves as such in a cost effective manner, and therefore to be on the receiving end of these benefits: they receive a higher level of service (which many increasingly time-starved buyers appreciate) and, should they choose to dedicate part of their time and attention to viewing advertisements or otherwise listening to a sales pitch for a particular brand of product, they will get handsomely rewarded for paying attention at a time when their attention and consideration is worth the most.

Note that past purchase behavior is for many products and services a good indicator of future purchase behavior, but it is not perfect: Consumers with similar purchase histories, might still have different degrees of intent when they express interest in a future purchase.

In one set of inventions, it is an object to obviate the need for an assessment of a buyer entity's serious intent to purchase by either assessing a penalty/price for the receipt of benefits if no purchase is made, or by withdrawing or otherwise making the benefit contingent on the buyer entity purchasing the product, so that there is no or little cost associated with the provision of the benefit by the advertiser/seller.

A further invention is directed to a computer implemented method for determining a serious intent by a buying or buyer entity to purchase a good or service, after receipt of a Declaration of Intent to purchase that good or service. It should be noted that in the context of the present invention, the term “buyer entity” is intended to be broadly construed to encompass both individuals and businesses.

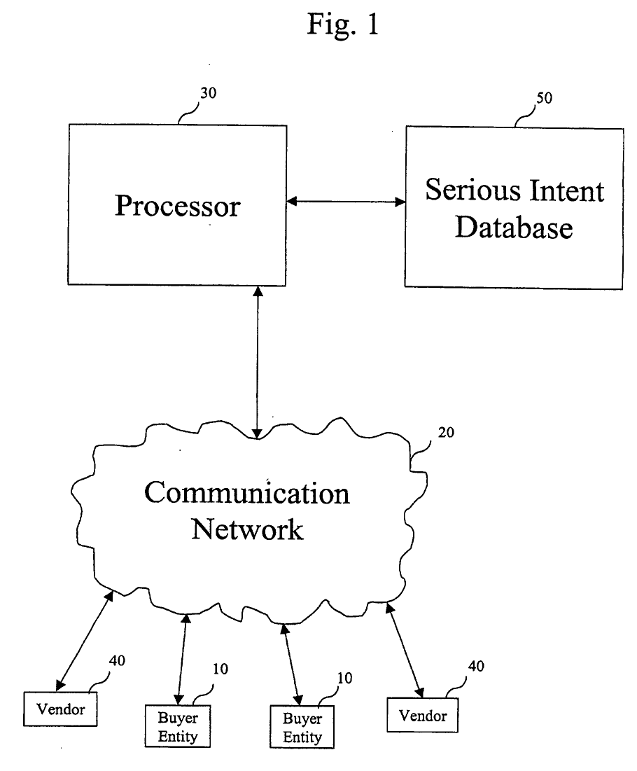

Referring now to FIG. 1, there is shown a block diagram illustrating the high level components of a preferred embodiment of the present invention. A plurality of buyer entity computer systems 10 are connected through a communications network 20. Each of the plurality of the buyer entity computer systems 10 could include portions of the processing software to be discussed below. Alternatively, each of a plurality of the buyer entity computer systems 10 could be connected through a communications network 20 to one or more processors 30 that contain the processing software to be described. Additionally, it is contemplated that one or more vendor computers 40 will be connected to the communications network 20. Additionally, it is contemplated that there be a one or more data bases 50 for storing serious intent information about the various buyer entities.

In a preferred embodiment, the communications network 20 is the internet. However, the communications network 20 can also include a wide area network (WAN), an internet network, a public tariff telephone network or a private value added network (VAN). Alternatively, the communication network can be implemented using any combination of these different kinds of communication networks. It will be appreciated that many other similar configurations are within the abilities of one skilled in the art and all of these configurations could be used with the method of the present invention. Furthermore, it should be recognized that the computer system and network disclosed herein can be programmed and configured in a variety of different manners by one skilled in the art, to implement the method steps discussed further herein.

The buyer entity blocks 10 in FIG. 1 are conveniently configured as computers which may communicate with the communications network 20. If the blocks 10 were implemented as computers, they would typically include customary components of a computer system including a CPU, a display, a keyboard and/or other I/O device, a network or communications interface, RAM or ROM or other memory, as well as storage such as disks and/or CD/ROM drives. However, the present invention is not limited to the use of computers by buyer entities. In this regard, information can be obtained from a buyer entity through a variety of convenient mechanisms, including hand held devices operated by the buyer entity, or by means of a third party indirectly inputting the buyer entity information into the communication network 20. Likewise, the blocks 40 representing the vendors, will also typically be implemented by means of a computer, but could also be implemented by hand held devices or other convenient devices.

The processor 30 is representative only, and may be comprised of a single processor. Alternatively, the functionality of the processing system could be implemented with several processor systems that are connected over a network. It is also possible to distribute the functionality of the processing system over a multitude of sites which are suitably connected together using conventional networking or inter-networking techniques.

The serious intent data base 50 may be implemented by a single data base structure at an appropriate site, or by a distributed data base structure that is distributed across an intra or an internet network.

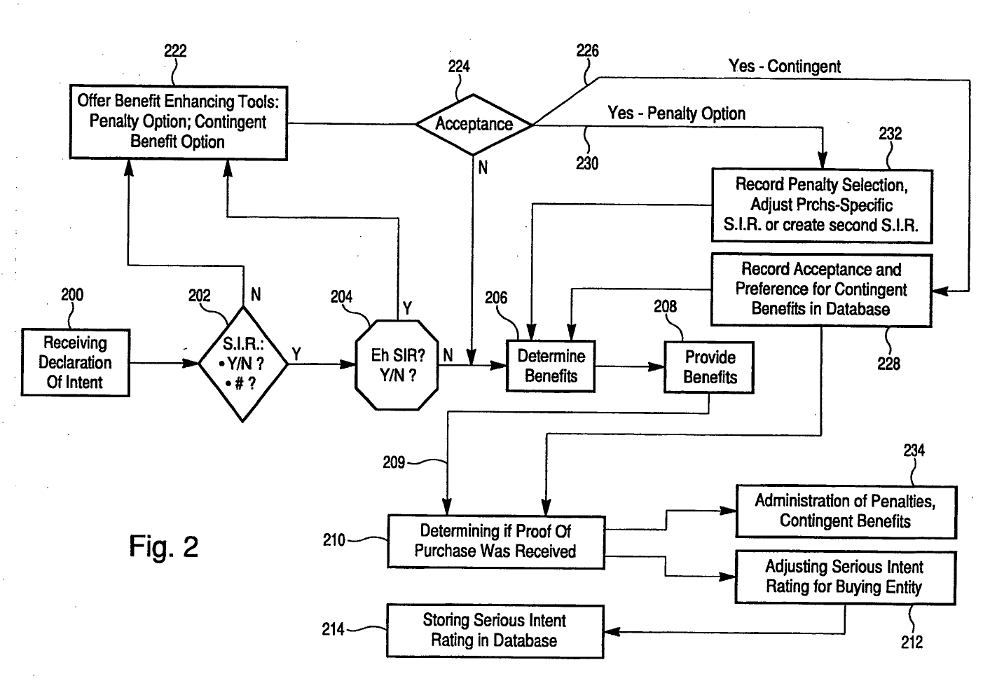

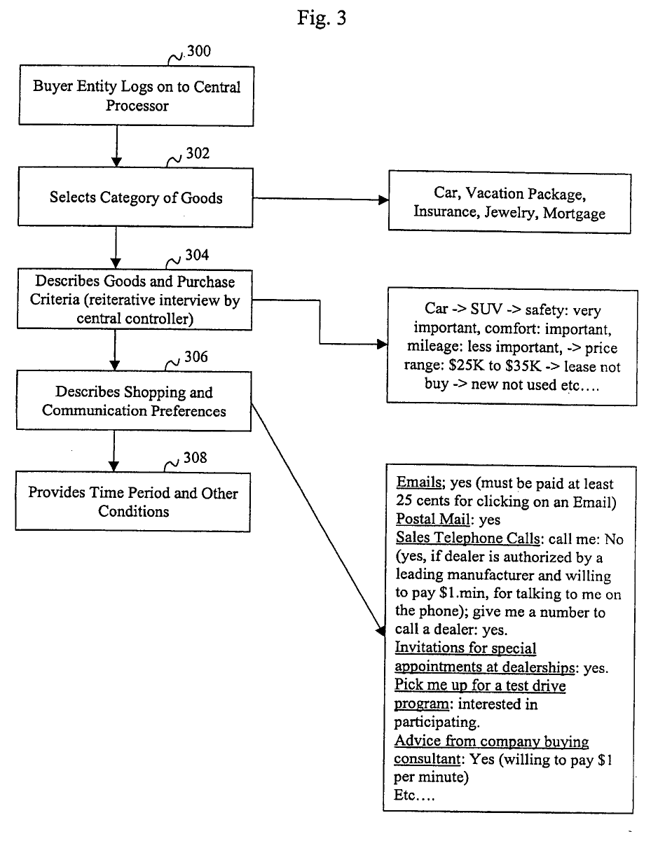

Referring now to FIG. 2, here is shown one embodiment of the method and system of the present invention. The system and method begin their operation with the receipt of a declaration of intent to purchase a good or a service at block 200. The details of the operation of this block 200 will be provided with respect to FIG. 3.

Referring now to FIG. 3, there is shown a schematic block diagram providing more detail on several aspects shown in FIG. 2. In this regard, block 200 in FIG. 2 can be implemented, as shown in FIG. 3, by the buyer entity logging, per block 300, onto a central processor. This login process would typically include the input of the buyer entity's ID, or the assignment of an ID to a buyer entity that is using the system for the first time. The ID would be used to track/reference buyer entity declarations, purchases and other information, which could be stored in the serious intent database 50 under the ID. The login process onto the system of the present invention could be accomplished via an intranet or via the Internet. By way of example but not by way of limitation, for an Internet implementation the browser of the buyer entity would browse to an appropriate web site for the system, which web site would then serve appropriate web content including a graphical user interface back to the buyer entity's browser.

The method would then move to block 302 and the buyer entity would select a category of goods or services in which it is interested. By way of example, this category could be automobiles, vacation packages, insurance, jewelry and mortgages. The method would then move to block 304, wherein the buyer entity would describe the goods and the buyer entity's purchase criteria. By way of example, for an automobile, the buyer entity could designate an SUV, could designate that safety is very important, that comfort is very important, that mileage is less important, indicate a price range of $25000-$35000, indicate buy not lease, and indicate new not used.

The method could then move to block 306, wherein the buyer entity would describe shopping and communication preferences. By way of example but not by way of limitation, the buyer entity could indicate that it would be willing to receive communications in the form of email advertisements, but might further set a threshold of being paid at least $0.25 for clicking on the email. The buyer entity might further indicate that it would be willing to receive postal mail that includes advertisements and would be willing to receive sales telephone calls only if the dealer is authorized by a leading manufacturer and willing to pay $1.00 per minute for talking to the buyer entity on the telephone. The buyer entity could also indicate that it would be willing to receive invitations for special appointments at a dealership or that the buyer entity would be willing to be picked up for a test drive or that the buyer entity would be willing to listen to advice from a company buying consultant, provided that the company was willing to pay that buyer entity some threshold amount per minute of time on the telephone with the consultant, such as $1.00 per minute.

The method would then move to block 308, wherein the buyer entity could set down the time period during which he intends to make a purchase of the good or service and could also set down various other conditions, and could then make the declaration of intent to purchase the good or service.

By way of example, this declaration of intent could be communicated by the buyer entity clicking on a button or other graphics on a graphical user interface (GUI) display on its computer or other display. Alternatively, the buyer entity could be presented with a series of buttons or other types of graphics which would indicate a series of gradations of serious intent to purchase a service or a good. The buyer entity could click on or otherwise manipulate an aspect of the graphics in the GUI in order to provide an indication of the level of the buyer entity's serious intent, which could then be communicated over the communication network 20 to the processor. Alternatively, the buyer entity could describe his level of intent to purchase the product or service in words. These words would then have to be interpreted by the system by selecting certain key words and correlating those key words to a level of the buyer entity intent to purchase the product or the service.

Referring again to FIG. 2, the operation would then proceed to block 202, wherein the system would determine whether the buyer entity has a serious intent rating by querying the serious intent database 50 with the buyer entity ID. The serious intent rating is a number or other indication used to estimate the likelihood that the buyer entity will make the purchase of the good or service. There are a variety of methods available to calculate a serious intent rating for a buyer entity. By way of example, but not by way of limitation, one way of estimating the likelihood that a buyer entity which declares that it intends to buy a product or service will indeed make a purchase which approximately conforms to that declared intent is to determine whether and how often that same buyer entity has in the past—after making a similar declaration of intent—made a purchase that conformed to those earlier declarations. Therefore, by way of example, but not by way of limitation, a serious intent rating for a buyer entity could be calculated based on the factors of the number of times that the buyer entity has declared that it would purchase a product or service and the number of times that proof that the product or service was purchased was received by the system for that buyer entity. For instance, assume Fred Miller has used the “Serious Intent System” three prior times: First he declared his intent to buy a television (estimated value $300) and did make that purchase as per a submitted proof of purchase. Second, he submitted a declaration of intent to buy a new bed with an estimated value of $200, but he did not submit a proof of purchase in respect to that declaration of intent. Third, he declared his intent to buy a video camera (estimated value $1000) and he submitted a proof of purchase showing that he purchased the product. As one example of such a calculation, assume his serious intent rating were to be calculated based on the number of times that proof that the product or service was purchased was received by the system for that buyer entity divided by the number of times that the buyer entity has declared that it would purchase a product or service. His rating therefore would be ⅔, which is 66 percent. Typically there would be a limit on the time period within which the proof of purchase could be submitted to the system by the buyer entity or a third party. Additionally, the step of calculating the serious intent rating of a buyer entity might also include as part of the calculations the factors of the total amount of money that the buyer entity has actually spent (based on serious intent declarations which were followed by conforming proof of purchase records) for products or services over a predetermined time period divided by the total amount of money for the product and/or service that the buyer entity has declared a serious intent to purchase over this period of time. For the example above, if the amount spent on the basis of proofs of purchase were to be divided by the amount of the value of all items declared in Fred's Serious Intent declarations, his ratings would be 1300 (value of TV and video camera for which he submitted proofs of purchase)/1500 (value of all items)=about 87 percent. In a preferred embodiment of this method of calculations, the serious intent rating is partly calculated using the number of times that the buyer entity has submitted a proof of purchase related to a declaration of serious intent within a predetermined time period divided by the total number of serious intent declarations, and partly calculated by dividing the total amount of money spent in relation to serious intent declarations by the total amount of money for the product and/or services for which the buyer entity has made serious intent declarations. In the example above, Fred's Serious Intent Rating could for example, be determined by assigning a 50 percent weight to each of the two methods of calculating a rating, giving a total rating equal to ((0.5)times(0.66))plus((0.5)times(0.87))=about 76.50 percent.

In a further aspect of this embodiment of the invention, the method could include the steps of determining a category for the good or services designated in the intent to purchase from a set of categories. By way of example, a category could be designated for each of a plurality of companies. Alternatively, each of a plurality of categories may represent a set of merchants, or an aggregation of products or services of a certain type, or of a certain value, or for example that meet a certain threshold amount for a given category. By way of example, there could be a category of Neiman Marcus purchasers, or more generally of department store purchasers, discount shopper purchasers, jewelry purchasers, Borders Bookstore purchasers, luxury item purchasers, brand name purchasers, risk adverse purchasers, etc.

If the step is included of categorizing goods or services designated in the intent to purchase declaration, then the step of obtaining a serious intent rating could include the step of determining the serious intent rating for the buyer entity in the determined category of goods of services. Such a serious intent rating could be calculated using the above noted factors or other convenient factors using information from that category. As a further aspect of the present invention, the calculation of the serious intent rating could include the step of calculating a class serious intent rating for a particular buyer entity in accordance with a function of the separate serious intent ratings of a plurality of selected categories for the particular buyer entity. For example, a class serious intent rating for the class of luxury goods could be calculated by simply adding or performing some other function with the serious intent ratings for luxury automobiles, expensive jewelry, and million dollar homes to obtain the luxury goods class serious intent rating.

Note that there are a variety of different ways to calculate the serious intent rating, or to generate an initial serious intent rating. One of the ways of assessing the probability, e.g., the serious intent rating, of whether a buyer entity who has made a purchase intent declaration will indeed make a corresponding purchase is to examine prior purchase records of the buyer entity. If the buyer entity has frequently purchased similar items in the past, it becomes more likely that its intent declaration will be followed by a purchase. Accordingly, it is in the interest of advertisers to convey particularly attractive benefits, such as pre-sale services and lucrative pay to view advertisements to such a buyer entity. It is in the interest of a buyer entity to receive such benefits, and a buyer entity therefore has good reason to make its past purchase records available. Note that the probability/serious intent rating for the buyer entity could be calculated or set using any of a variety of algorithms and/or setting rules, e.g. setting the serious intent rating to a first default level of the buyer entity has made at least one purchase of the declared good or service within the last 12 months. The past purchase records could be obtained and loaded into the system in the same manner as described for the proof of purchase records.

In a basic configuration of this embodiment of the present invention, the method would then proceed to block 206, wherein a determination would be made of at least one benefit that is associated with the intended purchase, based on the serious intent rating for the buyer entity. It should be noted that this determination may be made directly by the present system, or may be made by a third party vendor. This step would typically be accomplished by correlating the good or service with a predetermined benefit that had been previously associated with that good or service for that level of serious intent rating in a data base. Alternatively, the good or service could be correlated with one or more vendors that could directly or indirectly determine an appropriate benefit based on the serious intent rating of the buyer entity.

By way of example but not by way of limitation, the particular benefits provided directly by the system or by a third party vendor might include
1. A Reward for reading and responding to advertisements on line and off line;
2. An Offer of exclusive promotional discounts or rewards or rebates;
3. Provision of superior pre-sale service to the buyer entity;
4. Sending communications tailored to the specific purchase preferences of the buyer entity; and
5. Provide other appropriate benefits. By way of example, an automobile manufacturer such as Cadillac could offer to provide the buyer entity that has declared a serious intent to purchase a luxury car with an offer to bring the car to the buyer entity's home for a test drive.

The various benefits determined in block 206 would then be provided in block 208 either directly by the system, or indirectly by a vendor associated with the system. As noted above, the provision of benefits block 208 could provide a variety of different benefits including a higher level of service, or special appointments with vendor personnel, or a display of special advertisements on the buyer entity's system, or special brochures sent to the buyer entity's home, or various other channel dependents benefits.

The method then proceeds to block 210, wherein it is determined if a proof of purchase has been received within a predetermined period following receipt of the declaration of intent to purchase the good or service. Note that this time period could be calculated simply by adding a predetermined time period, such as six months, to the date that the buyer entity makes the declaration. Alternatively, the predetermined time period could be calculated by adding a predetermined time period to the end of a period within which the buyer entity indicated that it would be making the purchase. Note that the time frame that the buyer entity gives for the completion of its intended purchase might affects its serious intent rating: for instance, should the buyer entity be willing to review advertising information from a particular seller in exchange for a reward, the serious intent rating—and the reward that is calculated accordingly—will likely be higher if the purchase is more urgent and therefore more likely to be made soon after that advertisement is seen by the buyer entity. The determination as to whether the proof of purchase was submitted within the predetermined period of time could simply comprise determining if the period of time has elapsed without the receipt of a proof of purchase.

In one implementation of this block 210, buyer entities could submit information on their credit card statements and other verifiable information as proof that the product or service was purchased. This information is then entered into the serious intent database 50 and associated with the unique membership ID for the buyer entity. A variety of different records and mechanisms for obtaining those records could be utilized in order to implement block 210. Some of the variety of options for receiving the proof of purchase information in block 210 are as follows:

Hard Copies

1. Purchase Record maintaining company (credit card company, frequent flyer company etc . . . ) sends copy to buyer entity.

2. Buyer entity mails or faxes hard copy or original to the system and indicates whether the statement is a copy or the original and potentially designates the purchased item that correlates to the buyer entity's earlier declaration of intent to purchase.

3. If a statement is the original, the system may make a copy and send original back to the buyer entity.

4. The system entry operator prepares the statement for entry into the database and enters the data. Note that the entry of the information into the database could be manual, or partly or almost entirely automated thru the use of Optical Character Recognition Software and the development and programming of routines that are applicable to different types of statements. (“Automated Entry”) This step could include the system entry operator or the scanning system electronically searching the statement for an item that was earlier designated by the buyer entity with that ID with a declaration of an intent to purchase.

5. Entries are recorded into the database 50.

Online Entry of Summary Statements

1. Buyer entity retrieves statement online (or scans hard copy)

2. Buyer entity saves and downloads statement in a file.

3. Buyer entity transfers the statement by Email or through Web application to the system.

4. The system entry operator prepares the statement for entry into the database and enters data making partial or full use of Automated Entry as described above.

5. Buyer entity has option of editing the statement and deleting selected records, if any.

6. Entries are recorded into the database 50.

Transfer and Entry of Online Transactions at Time of Transaction

1. Whenever a buyer entity enters a credit card number or purchases an item on its computer, a window could open asking the buyer entity if it would like to store the purchase record for download to the present system.

2. If the buyer entity answers YES, the system then automatically enters the purchase record into the database using the above described Automated Entry and categorization. Alternatively, the transaction record may be stored in a separate file on the hard disk of the buyer entity's computer; and the transaction record sent by Email to the serious intent data base 50. Note that the buyer entity's computer could send the data in batch mode or on an ad hoc basis.

If an ID number is assigned to the buyer entity, then it will be included in the transmission. This transmission may be performed automatically. Alternatively, the buyer entity may be asked each time or periodically for permission to forward the purchase history to the system and this transmission is performed, if the buyer entity responds in the affirmative.

Automated “Robot” online Scanning of Purchase Histories

1. The Buyer entity enters its username and password for various third party accounts that contain purchase records.

2. The processor 30 automatically logs on to these various accounts, retrieves and stores purchase histories using Automated Entry.

3. Optionally, the buyer entity may be given the right to edit these statements prior to entry in the database.

4. The Statement is stored in the database 50.

Technology for such online retrieval and scanning of data from various accounts already exists. Two companies, Yodlee and Avaya, have sold the use of this technology to various consumer web sites, such as Yahoo. In this instance, the consumer gives its access password to the site so that the site can access and download account information. Thus, these consumer web sites allow consumers to view their personal account information, which is compiled from various online accounts, in one “place” on the web, consolidated on a single online page or online statement. This helps consumers have more immediate access to the information that resides in various disparate accounts without having to go to multiple web sites and to type in their password and username multiple times.

Yet another way that a buyer entity can submit a proof of purchase automatically is by using a credit card that has been issued by the system of the present invention, or a company affiliated therewith. The buyer entity could also use a smart card which stores information on the purchases of the buyer entity in a microchip of the card itself, and later makes the information available by means of a card reader that transmits the information contained in the card to the processing system when the card is inserted.

During the process of receipt of buyer entity identity information and purchase history information, or thereafter, the buyer entity identity information could be verified by comparison of the received identity information with the information in one or more databases containing identity information. Alternatively or in addition, buyer entity digital signatures or digital certificates or other methods of electronic verification or telephone verification could be used. Additionally, the third party merchants identified in the third party proof of purchase records received from the buyer entity that constitute the buyer entity purchasing history, could be compared to a database of third party merchants to verify that the proof of purchase record is valid. This verification could also be accomplished by electronically or manually contacting the third party merchant to obtain verification of the proof of purchase record.

The method then moves to block 212 wherein the serious intent rating for the buyer entity is recalculated based on the proof of purchase information submitted in block 210. This recalculation step in block 212 is simply comprised of updating the parameters used in the serious intent rating calculations and then performing that calculation with those updated parameters. The method would then move to block 214, wherein the serious intent rating is stored in the serious intent database 50.

In a further aspect of this embodiment, whether or not the buyer entity has a serious intent rating, the buyer entity could be offered benefit enhancing tools or options in block 222. The purpose of these tools is to allow the buyer entity to increase its serious intent rating by availing itself of other methods of demonstrating the seriousness of its intent. In the case of the contingent benefits option described below, the purpose is to obviate the need for a high serious intent rating by making the benefits that the buyer entity receives contingent on its later submission of a proof of purchase. Block 222 would be reached by the method directly from the decision block 202, if the buyer entity is determined not to have a serious intent mechanism. If the buyer does have a serious intent rating, then the buyer entity might be presented in block 204 with a screen in the GUI that provides the option of enhancing the buyer entity's serious intent rating for the particular purchase it intends to make, or the option of receiving other benefits by using one of the benefit enhancing tools in block 222. In particular, block 204 could show the buyer entity its serious intent rating and/or benefits available, and make recommendations or describe how one or more benefit enhancing tools could be used to enhance the buyer entity's serious intent rating. If the buyer entity desires to review these benefit enhancing tools, it would then click in order to move to block 222. Block 222 would provide descriptions of one or more benefit enhancing tools.

By way of example but not by way of limitation, one such tool could be a button or other indicator allowing the buyer entity to elect to receive a benefit in the form of fee-based (e.g., a price is charged to the buyer entity) higher than normal levels of sales service and purchase guidance from one or more vendors. These one or more benefits might be offered with the understanding that the buyer entity would receive a reimbursement for any fee payments it made or was charged for the enhanced services contingent on the receipt by the system, as indicated by block 210, within a predetermined period of time of a proof of purchase indicating that the buyer entity has indeed made a purchase in the previously specified category.

In a preferred embodiment, contingent benefits might comprise payments or credits for reading or interacting with advertisements. In this regard, advertisers could promise special rewards to buyers for reading or viewing at least one advertisement for a particular product, contingent on the buyer entity later submitting proof that it indeed purchased that product or a similar product either from the advertiser himself or from a competitor. The purpose of this operation is as follows: By paying a reward that is contingent upon later proof of purchase submission, the advertiser assures himself that he only pays these special rewards to consumers who are actively considering a purchase of the type of product that he sells. If the advertiser would define the group of reward recipients more narrowly, and give rewards only to those buyers who later purchase the particular brand of product that he advertises, the buyer entity would have to bear the risk and cost of spending time on an advertisement that advertises a product which might be of inferior quality or value. It is however the advertiser who has the information about his product (and who wishes to convey this information to the buyer entity), not the buyer entity. By promising to reward the buyer entity for considering information on his product, the advertiser compensates the buyer entity for his time and consideration at a level that is superior to the reward he could afford to pay to everyone, irrespective of their purchasing intentions. By making the reward contingent upon a product in his general product category, rather than limiting the provision of the reward to those who buy his product, he offers the buyer entity attractive compensation for his time without linking that compensation to the buyer entity's patronage of his own particular brand of product or service.

For instance, assume that Helmut Fiala seriously intends to buy a laptop computer within the next month (in addition to the desktop computer he currently owns) for about $2000. However, this is the first time he uses the herein described Serious Intent System, and he therefore has no pre-existing Serious Intent Rating, which would allow him to demonstrate that he is serious in his intent to buy a laptop. Assume further that Helmut is almost certain that he is going to buy a laptop within the next four weeks, but that he does not know which particular brand to buy (as is typical for many computer buyers several weeks prior to their computer purchase). He therefore indicates his willingness to receive so-called contingent benefits. In return, he is offered a reward equivalent to $1 per minute of his time to view and respond to three 10 minute web-based advertisement. These advertisements comprise several screens of information about the product features and advantages of brands from three advertisers. Helmut chooses to view these advertisements and to answer questions on various product features that are designed to verify that he is paying attention to the advertisements. A local retailer called CompuHeaven also decides to vie for Helmut's business, and offers to provide another type of contingent benefit to Helmut as follows:

CompuHeaven's main store is normally a very well frequented. One often has to wait to get product questions answered from one of the busy sales representatives, who usually have to juggle attending to several customers at the same time. CompuHeaven is willing to allow Helmut to make an appointment with a “personal shopping assistant” who is going to show to Helmut several of the leading brands, and dedicate himself to answering Helmut's questions about the differences between the various models that Helmut might want to consider. The appointment with the “personal shopping assistant” will last for one half hour. However, this service is offered to Helmut on a fee basis, e.g., $20, which fee may be forgiven or reimbursed, contingent on the submission of a proof of purchase. If he does not later submit a proof of purchase showing that he has indeed purchased a laptop as he said he might, he will not be reimbursed the $20 or a charge may be applied to his credit card. The $20 fee is to help reimburse CompuHeaven to defray the cost of the shopping assistant's time. For Helmut, this is an easy bargain: CompuHeaven is only a 10 minute bus ride from his home. Helmut is almost certain that he will be buying a laptop. He can therefore easily avail himself of a much higher level of pre-sale service than the service he would otherwise get, at a cost that in all likelihood will ultimately be zero. With the help of the dedicated salesperson of whom he will be able to avail himself, he will learn more in 30 minutes than he would researching different computer models on his own in three hours. For CompuHeaven it's also an easy bargain to make. Assume their research has shown that on average only 20 percent of the shoppers who are entering their store, and who ask questions about a new computer model of one of their salespeople, will actually be making a computer purchase in the near future. By dedicating a salesperson for a one half hour to someone who is very likely to make a purchase, CompuHeaven significantly increases its likelihood to close a sale. Moreover, if they succeed in gaining a new customer, they can expect to obtain a significant proportion of Helmut's repeat business as well as of some of the software purchases he will be making for his computer.

The foregoing operation is represented in FIG. 2 by the blocks 224, 228, 210 and 234. In this regard, if the buyer entity clicks a button or otherwise indicates acceptance of the contingent benefit option, as indicated by line 226, then his/her acceptance of the contingent benefit option and his/her selection of the benefit (for example, payments for reading/interacting with advertisements or receiving fee-based enhanced services) is recorded in the system, so that the appropriate contingent benefit may be given upon receipt of a proof of purchase. For the fee-based service selection, receipt of a payment, for example, by obtaining a credit card, could also take place at this time. This recordation operation by the system, typically using an ID for the buyer entity, is represented by block 228. The advertisements or fee-based services are then determined in block 206 and provided in block 208. The system then determines in block 210 if a proof of purchase has been received by the buyer entity within the predetermined period of time relating to his/her declaration. This operation will be discussed in more detail below. Then the operation moves to block 234, wherein benefits are provided to the buyer entity, if the requisite proof of purchase has been received. Such benefits, as noted previously, could comprise crediting the buyer entity's account for advertisements that the buyer entity watched or interacted with. Likewise, the benefit might be crediting back to the buyer entity the fee paid for the fee-based services, or not debiting the buyer entity's account.

An additional benefit enhancing tool that may be offered in block 222 is a penalty option. The purpose of the so-called “penalty option” would be to allow a buyer entity which feels that it is very likely to buy a particular product in the near future, to enter into a contractual agreement which would obligate it to pay a certain penalty in the event it does not submit proof of a purchase which approximately corresponds to its declaration of intent. Advertisers would be willing to confer higher benefits on the buyer entity than they would in the absence of such an agreement. This is because the buyer entity's willingness to incur such a penalty in the event that it does not make the intended purchase demonstrates to advertisers and sellers that the buyer entity is likely to seriously intend to buy the product. This mechanism is somewhat different from the “Contingent Benefit” mechanism in which the buyer entity receives a fee based service as a benefit on the condition that it reimburses the provider of that service for its full or partial cost in the event that it does not submit a proof of purchase (or is not reimbursed if the fee is paid at the time of receiving the service). For the contingent benefit option that involves payment for services, a buyer entity that does not provide a proof of purchase must ultimately pay only for those services that it chooses to avail itself in step 208, and which were specifically provided to it on the condition that it make a cost-defraying payment at the time of the service or in the event that it does not make a purchase. In contrast, the penalty option is a one time penalty agreement entered into by the buyer entity at the beginning of the program in block 224. Avoidance of the penalty payment depends only on the proof of purchase submission and not on the type or the amount of services of which the buyer entity avails itself. Moreover the size of the penalty does not vary with the activities of the buyer entity. Also, the penalty is used for the purpose of allowing the buyer entity to signal or prove the seriousness of its intent to potential sellers and advertisers. In the event that the penalty is paid by the buyer entity, its proceeds are not necessarily used for the purpose of reimbursing sellers or retailers for the provision of services. (For instance, the penalty might be retained by the company acting as the operator and administrator of the Serious Intent system or for other purposes.)

Referring to the example above, had Helmut Fiala been offered a penalty option for enhancing the benefit of his intent instead of the contingent benefit option, and had he availed himself of that penalty option, he might have agreed to pay $50 in the event that he does not submit a proof of purchase for the laptop or might have paid $50 in advance, which could be reimbursed on the submission of the proof of purchase. Based on his willingness to agree to a penalty payment in such an event, laptop advertisers and sellers could then have offered him the equivalent of $1 per minute for viewing laptop advertisements or for the availability of a personal shopping assistant at various participating computer stores at no charge. In the event that Helmut does not submit his proof of purchase, he would have to pay the $50 penalty (and his serious intent rating might be adjusted downwards for the purpose of future uses of the service), but he would have received the rewards for viewing advertisements and would not have to return these rewards, nor would he have to reimburse computer stores such as CompuHeaven for the services that they agreed to provide to him at no charge in the (in his case, erroneous) expectation that he would purchase a laptop.

Referring to FIG. 2, if the buyer entity accepted this penalty option in block 224, then the method would provide a screen GUI asking the buyer entity to place a deposit of value of some type, or an authorization to obtain something of value of the buyer entity to facilitate a future payment of the penalty if a proof of purchase is not received within the predetermined period of time at block 210. By way of example but not by way of limitation, this screen for block 224 could be implemented by a screen presenting the option to the buyer entity to input the buyer entity's credit card number and a penalty amount, which may then be immediately obtained from the account or obtained from the buyer entity's account at some later time such as when the predetermined period has elapsed. Note that the screen may offer the buyer entity various amounts of penalties, with a different level of adjustment of the serious intent rating and the ensuing benefits associated with each different penalty level.

The method would then move to block 232 wherein the penalty selection is recorded in the system database and an adjustment of the serious intent rating is temporarily or permanently made for this particular purchase due to the selection of the penalty option. Alternatively, a second serious intent rating could be generated that reflects the impact of the buyer entity's acceptance of the penalty option. This second rating would contrast with the first serious intent rating, which reflects the buyer entity's prior track record for previous serious intent declarations. The first serious intent rating would be used separately, depending on whether there is a pre-existing serious intent rating for the buyer entity. The purpose of having a second serious intent rating which separately measures the level of intent that can be inferred from the penalty agreement is to allow advertisers that pay different credence to levels of intent inferred from that penalty agreement than they do for levels of intent inferred from the prior serious intent history of the buyer entity to adjust and calibrate their benefits accordingly (and/or to allow the system operator to vary the weights of the two serious intent ratings depending on the particular product that is being offered and the differing correlations of these ratings to purchases of these products).

This adjusted serious intent rating and/or the second serious intent rating by itself or in conjunction with the unadjusted serious intent rating is then used by block 206 to determine, based on that particular adjusted serious intent rating, a benefit or series of benefits available to the buyer entity for that particular category of good or service. As noted previously, this determination would be made by correlating the category of good or service and the serious intent rating level with predetermined benefits offered by one or more vendors.

The method would then move to block 208 wherein the various benefits are provided either directly by the vendors or by the system itself. The provision of benefits will generally come in the form of various offers for such benefits that are presented to the buyer entity, and of which the buyer entity can avail itself. The process represented by blocks 206 and 208 generally starts after the buyer entity submits its declaration of intent and avails itself of benefit enhancing tools, if any, and generally ends when the buyer entity submits its proof of purchase or when the time period given to the buyer entity for submission of his proof of purchase has elapsed. Note that the “Determine Benefits” step and “Provide Benefits” step could happen multiple times during this time period. As the buyer entity avails itself of some benefits, that activity might be captured by the system and recorded in the database, and it might trigger the provision of additional benefits to the buyer entity.

The method would then move down to block 210 to determine if a proof of purchase was received. Typically, if a proof of purchase had been received, it would have been associated with the buyer entity's ID and his/her purchase declaration.

The method then moves to block 234 wherein the various contingent benefits and penalties, if any were selected, are administered, based on whether a proof of purchase for the good or service was received in block 210. In this regard, if a contingent benefit is involved, and the contingent benefit comprises a reward for viewing or interacting with advertisements, then the reward, such as a rebate or a deposit to the buyer entity's account or some other form of reward, is provided to the buyer entity. If the contingent benefit comprises the provision of a service, and the buyer entity has availed itself of that service, then the submission of a proof of purchase would trigger that any prior authorization to draw funds from the buyer entity for the purpose of helping defray the costs of the service would be canceled, or prior payments of such fees would be refunded or credited to the buyer entity's account. In contrast, the non-submission of a proof of purchase would trigger the withdrawal of funds from the buyer entity in the amount of the agreed upon charge for the costs of the service, or the removal of any indication in the system database record for the buyer entity of the possibility of a refund or a credit for this earlier payment.

Likewise, if the penalty option has been elected, then if the proof of purchase was received, then the penalty amount is refunded to the buyer entity's account or the authorization to obtain the penalty is cancelled. Likewise, if no proof of purchase was received by block 210 within the predetermined period of time, then in the case where only an authorization has been obtained from the buyer entity, the amount designated is actually obtained from the buyer entity's account by means of this authorization.

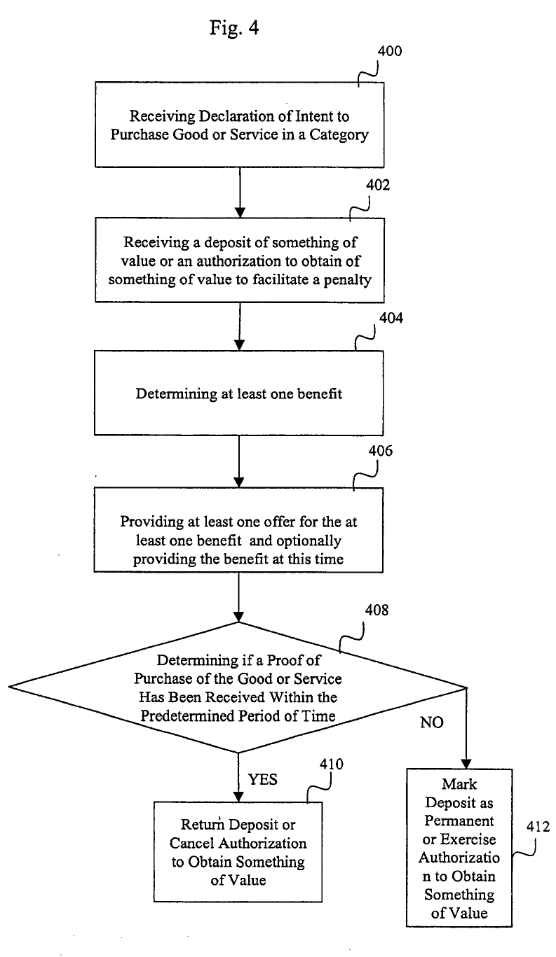

In a further related invention, a method could be provided for determining a serious intent to purchase a good or service that does not initially rely on a pre-existing serious intent rating. A buyer entity which agrees to incur a penalty in the event that it does not make a purchase (as documented by a proof of purchase) in a particular category of goods and services demonstrates that it seriously intends to make such a purchase. Accordingly, the buyer entity would reap benefits from advertisers and selling entities wishing to influence the buyer entity's purchase. By way of example, these advertisers and selling entities could be providing a greater level of pre-sale service to such a buyer entity or could be paying or otherwise rewarding the entity to read or view advertisements relating to its impending purchase. All of the earlier discussion relating to the purpose and functioning of the previously described penalty option applies to this invention. Referring now to FIG. 4, one such embodiment directed to the use of a penalty is shown. The method described in this embodiment comprises a first step in block 400 of receiving a declaration of intent to purchase a good or service in a category.

The method then moves to block 402 wherein a deposit of value or an authorization to obtain something of value is received to facilitate a penalty, with the penalty being enforced if receipt of a proof of purchase is not received within a predetermined period of time. As noted previously, the penalty could be implemented by presenting the buyer entity with a screen with input blocks for receiving an account number authorization, and an amount of the penalty.

The method then proceeds to block 404 comprising the step of determining at least one benefit. The method then proceeds to block 406 wherein at least one offer for the at least one benefit is provided to the buyer entity, and optionally the benefit may be provided at this time.

The method then moves to block 408, which is a determination of whether a proof of purchase of the good or service has been received within the predetermined period of time. If the answer is YES, then the deposited amount from block 402 is returned, or the authorization to obtain something of value is cancelled. Likewise, if no proof of purchase has been received within the predetermined period of time, then the method moves to block 412 wherein the deposit is marked as permanent or the authorization to obtain something of value is exercised.

It should be noted that although it is preferred that the particular benefits provided be correlated with the category of the good or service involved, such a correlation step is not necessary for the provision of the benefit.

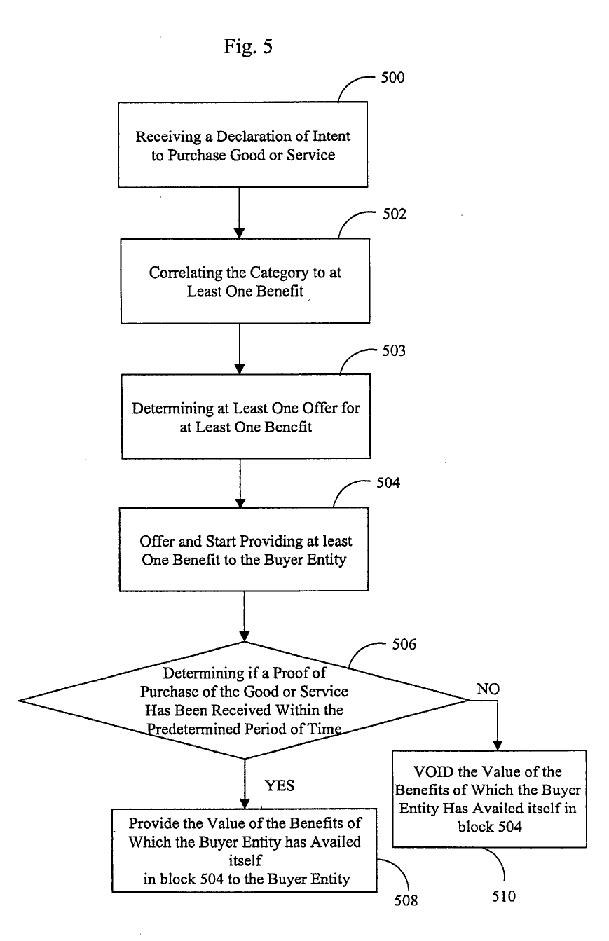

A further contingent benefit invention is shown in FIG. 5. Note that the prior discussion of contingent benefits applies equally to this invention. As stated previously, the purpose is to obviate the need for a serious intent rating by making certain benefits that the buyer entity receives contingent on its later submission of a proof of purchase. The method comprises a first step of receiving a declaration of intent to purchase a good or service in a category 500 within a predetermined period of time. The method then moves to block 502 wherein the category of the good or service involved is correlated to at least one benefit.

The method then moves to block 503 wherein at least one offer for at least one contingent benefit, e.g., is determined. The at least one benefit determined in this step is called a “contingent benefit” because the value of certain a benefit is fully or partly contingent on later submission of a proof of purchase by the buyer entity. For instance, if the buyer entity is paid $10 for viewing an infomercial of a particular brand of product of the type that the buyer entity says it is intending to purchase, the payment of this $10 is contingent on the buying entities later submission of a proof of purchase which shows that it indeed purchased that type of product after it saw the infomercial. However, in this example, the buyer entity need not, as previously explained, necessarily have bought the particular brand of product that was advertised in the infomercial to get the $10. It could purchase a competing product, and still get the $10 for agreeing to view an infomercial at the time that it was considering a purchase in the relevant product category. The requirement for the later submission of a proof of purchase is never so narrowly defined as to mandate that the purchase be made from only one particular vendor. If the benefit were contingent on such a narrow requirement, the method described here would be no different from a purchase rebate or other sales incentive, the like of which can be found frequently and has been used by many vendors for many years. 1

The method then moves to block 504 wherein at least one contingent benefit is offered to the buyer entity, an acceptance of at least one contingent benefit offer is received from the buyer entity for the process to move forward, and wherein this at least one benefit is partly provided to the buyer entity. For example, if the buyer entity is offered a reward to view an advertisement, that advertisement is shown in block 504 to the buyer entity. As a further example, if the benefit comprises a free service provided to the buyer entity that service is provided to the buyer entity under the condition that it later reimburse the provider of the service for at least part of the cost in the even it does not submit a proof of purchase. Some of these benefits are provided in block 504, and, in a preferred embodiment of the invention, the value to be associated with the value to be associated with these benefits depends on the fact that the buyer entity take certain actions which are associated with those benefits at a time that it has not yet made the purchase that it is actively considering. However, the buying entity does not get the full value of the benefits until after it has made the purchase, and proof of that purchase has been submitted, when the process reaches Block 508.

nln block 506, it is determined if a proof of purchase of the good or service has been received within the predetermined period of time. If the proof of purchase of the good or service has been received within the predetermined period of time, then the value of the contingent benefit referenced in the incentive offer is provided to the buyer entity in block 508. For instance, if the benefit comprises a special service provided to the buying entity, the value of that service is provided when the fee for these services is cancelled. Likewise, if no proof of purchase of the good or service is received within the predetermined period of time, then the method moves to block 510, and the value of the at least one benefit of which the buyer entity has availed itself in block 504 is voided.

In a further aspect of this embodiment, the declaration of intent step 500 could comprise receiving a declaration of the buyer entity's intent or willingness to purchase at least a specified volume of a product or service or of a category of products or services from a single selling entity over a specified time period. In this aspect of the invention, the receiving the proof of purchase step would comprise receiving the proof that an amount equal or higher than the specified volume was purchased by the buyer entity within the specified time period.

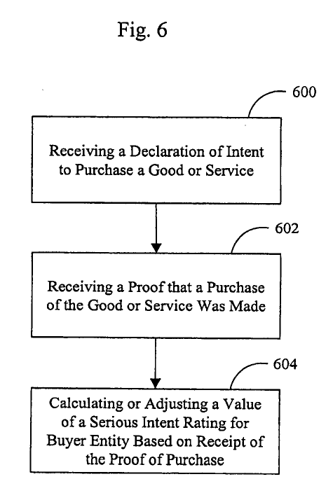

A yet further invention is shown in FIG. 6. In FIG. 6, the method begins with a first step 600 of receiving a declaration of intent to purchase a good or service within a predetermined period of time. The method then proceeds to block 602 wherein proof that a purchase of a good or service was made is received. The method then moves to block 604, which comprises calculating or adjusting a value of a serious intent rating for the buyer entity based on receipt of the proof of purchase.

A further aspect of this embodiment comprises receiving at least one further declaration of intent to purchase a good or service by the buyer entity, obtaining the serious intent rating, and determining or having determined at least one benefit that is associated with the intended purchase based on the serious intent rating for the buyer entity.

In a yet further aspect of any of the embodiments and inventions, the receiving a declaration of intent step comprises receiving a declaration of intent from a buyer entity in which it declares its intent to discontinue purchasing a product or service from a first selling entity from which it has previously purchased said product or service on a regular basis.

In a further aspect of the invention, an additional step is provided of further adjusting the value of a serious intent rating for the buyer entity based on receipt of proof that the buyer entity has purchased the declared product or service from a second selling entity that is different from the first selling entity.

In a yet further aspect of any of the embodiments of the present invention, the receiving a declaration of intent step could further comprise receiving a proof of purchase from a buyer entity which indicates the past level of spending on the product or service.

In a yet further aspect of the penalty embodiments of the present invention, the receiving a declaration of intent step could comprise receiving a declaration of intent from a buyer entity in which the buyer entity declares its intent to discontinue purchasing a product or service from a first selling entity from which it has previously purchased the product or service on a regular basis and, wherein the returning the deposit or canceling the authorization step in the penalty embodiment is contingent upon receiving a proof of purchase showing that the buyer entity has purchased the product or service from the second selling entity which is different from the first selling entity after submitting its declaration of intent.

Likewise, in a further aspect of the present invention generally, the receiving a declaration of intent step could comprise receiving a declaration of intent from a buyer entity in which it declares its intent to discontinue purchasing a product or service from a first selling entity from which it has previously purchased the product or service on a regular basis and, wherein the receiving the proof of purchase step comprises receiving a proof of purchase showing that the buyer entity has purchased the product or service from a second selling entity which is different from the first selling entity after submitting its declaration of intent.

In a further aspect of the present invention, the determination of the benefit step 206 could comprise the steps of sending a communication including the serious intent rating to a third party, and the receipt of an identification of at least one benefit from the third party.

In a further aspect of the present invention, the provide a benefit block 208 could be implemented by sending a third party a communication to initiate the provision of the benefit by the third party to the buyer entity.

In a yet further aspect of the present invention, if the serious intent rating database 50 does not have a serious intent rating for the buyer entity, then a default serious intent rating could be set for the buyer entity and used in further processing.

In a yet further aspect of the present invention, the determine a benefit block 206 and the offer of benefit enhancing tools block 222 could include certain benefits associated with one or more threshold serious intent ratings. For example, a threshold serious intent rating could be associated with an enhanced benefit in block 206. The step would be performed of comparing the obtained threshold serious intent rating to the serious intent rating of the buyer entity. The enhanced benefit associated with the threshold serious intent rating would only be provided to the buyer entity if the buyer entity serious intent rating equaled or exceeded the threshold serious intent rating. Block 206 could have a set of benefits, each with a different associated serious intent rating. One or more of these benefits would only be offered to the buyer entity when a comparison step determined that the serious intent rating of the buyer penalty equaled or exceeded the threshold serious intent rating threshold for that particular benefit.

Likewise, block 222 which offers various benefits or penalties as benefit enhancing tools might have some of the penalties and/or benefits associated with one or a set of threshold serious intent ratings. Accordingly, a comparison step would be included to determine whether the buyer entity's serious intent rating equaled or exceeded the threshold serious intent rating. Only if the buyer entity serious intent rating equaled or exceeded the threshold serious intent rating for a particular penalty or a particular benefit, would that penalty or benefit be offered to the buyer entity.

In a further aspect of the present invention, the block 202 of obtaining a serious intent rating might comprise receiving a serious intent rating for the buyer entity from an external third-party source. This could be achieved, by way of example but not by way of limitation, by communicating the product or service designation in the declaration and any pertinent attributes, over a network to the third party.

In a yet further aspect of the present invention, a step could be included of generating a charge to an advertiser or a vendor providing benefits, with the charge being a function of the serious intent rating of the buyer entity receiving the benefit. Again, the charge could be communicated to the advertiser or vendor over a network.

In yet a further aspect of any of the various embodiments of the present invention, a step could be included of determining an income level, i.e., an estimate thereof, for the buyer entity, and comparing the income level of the buyer entity to a threshold income level and only offering at least one of the benefits in blocks 206 or 222 when the buyer entity income level exceeds the threshold income level. The determination of the income level of the buyer entity could be obtained, by way of example, by accessing via a network a database that correlates buyer entity information, such as demographic information to income levels. For example, the zip code of the buyer entity could be correlated with an income level.

In a yet further aspect of any of the embodiments of the present invention, the block 200 of receiving a declaration of intent comprises receiving a designation of one from a set of levels of intent from the buyer entity, and wherein the determining a benefit block 206 comprises selecting or matching at least one benefit based upon this designated level of intent.

In a yet further aspect of any of the embodiments of the present invention, the steps are provided of determining a category for the goods or services designated in the intent to purchase in block 200 from a set of categories. As noted above, this could be accomplished by correlating the good or services to a category. The obtaining a serious intent rating step in block 202 could then comprise determining a serious intent rating for the buyer entity in the predetermined category for that good or service. This embodiment could further include selecting benefits in block 206 from vendors selling the designated goods for services in the determined categories.

In a yet further aspect of the present invention, the step is provided of calculating a class serious intent rating for a particular buyer entity in accordance with a function of the separate serious intent ratings of a plurality of selected categories for the particular buyer entity. For example, a luxury class serious intent rating could be determined based upon a function (such as addition) of the separate serious intent ratings for expensive jewelry, luxury cars, and luxury homes for that buyer entity.

In a further aspect of the present invention, the buyer entity may provide preferences for particular benefits in block 200. The determining benefits step in block 206 would then comprise selecting a group of benefits for presentation to the buyer entity based, at least in part, on the buyer entity preferences obtained in block 200.

In a yet further aspect of the present invention, the buyer entity may provide in block 200 a threshold value that any benefits must equal or exceed before the buyer entity will accept the benefits. Accordingly, the determining a benefit step in block 206 and the offer of benefit enhancing tools in block 222 could then be set to only provide benefits that meet or exceed this threshold value set by the buyer entity.

In a yet further aspect of the present invention, the provision of a benefit step in block 208 could comprise providing a plurality of benefits from different vendors/advertisers to the buyer entity, and further could include the steps of determining the sequence or the relative prominence of the plurality of the benefits based on the serious intent rating of the buyer entity.

In a yet further aspect of the present invention, the method would include obtaining non-purchase information about the buyer entity from a third party, typically via manual or automatic network access to a third party database, and recalculating the serious intent rating for the buyer entity based on this non-purchase information. By way of example but not by way of limitation, this non-purchase information could comprise demographic information about the buyer entity, which in one embodiment, could be correlated with an amount associated with that information. The recalculation of the serious intent rating based on this non-purchase information could comprise adding or subtracting a predetermined amount based on this non-purchase information.

In a further aspect, this non-purchase information could be searched to obtain at least one attribute about the buyer entity. This attribute could then be correlated to one of the benefits from among a plurality of benefits. This correlation step could be practiced in the step of block 206 of determining benefits or the block 222 of offering benefit enhancing tools. The correlated benefits would then be provided to the buyer entity in block 208 or blocks 228 and 234. By way of example, this non-purchase information about the buyer entity could comprise information that the buyer entity was a male living in Omaha, Nebr., who had just purchased a house. This information could be correlated with particular benefits that might be of interest to such a buyer entity.

In a further aspect of the invention, the method step is contemplated of sending the serious intent rating of the buyer entity to a third party after receipt of an authorization from said buyer entity. The serious intent rating could be mailed, faxed, or telephoned to the third party, but would most conveniently be provided over a network.

In a yet further aspect of the present invention, the serious intent rating for the buyer entity is electronically stored at a computer of the buyer entity. This storage could be performed, by way of example, automatically by web content included with the web page downloaded when the web site of the present invention is accessed by the buyer entity's browser. As another example, a screen in the web page could be provided to the buyer entity allowing him/her to initiate such storage.

In a yet further aspect of the present invention, the storing step comprises storing the serious intent rating on a cookie at the computer of the buyer entity.

In a yet further aspect of the present invention, the method includes the step of the buyer entity sending the serious intent rating to a third party. Again, this function could be accomplished automatically, or could be initiated from a screen presented by the web content on the browser.

In a yet further aspect of the present invention, the determining a benefit step in block 206 comprises comparing the serious intent rating of the buyer entity to a set of threshold levels, with a different predetermined benefit associated with equaling or exceeding each different threshold level in the set of threshold levels. The step would then be included of selecting the benefit associated with the highest threshold level exceeded by the serious intent rating.

In a yet further aspect of the present invention, the block 210 in the method of determining if proof of purchase was received comprises linking to a third party database and obtaining information therefrom on whether the buyer entity made a purchase of the good or services listed in the declaration and inputting this information to the database 50.

In a yet further aspect of the present invention, the method step of determining if proof of purchase was received in block 210 comprises receiving a proof of purchase record created by a third party source, and further comprising the steps of comparing the third party source of the proof of purchase record with a source database of third party sources and entering only those proof of purchase records if from third party sources that are in the source database. The third party source database could be conveniently accessed via a network, such as the Internet.

In a yet further aspect of the present invention, the method of the present invention contemplates the steps of storing the serious intent rating for the buyer entity on a cookie at a computer of the buyer entity, which may be accomplished as noted above. This aspect of the invention would further comprise providing code at the buyer entity's browser, by way of web content from a web page or via another convenient method, to permit a merchant to access the cookie and obtain the serious intent rating therefrom. The merchant would then correlate the accessed serious intent rating to at least one item of content, and serve to the browser of the buyer entity, or via another convenient method such as the mail or by fax or telephone, the at least one item of content.

In a yet further aspect of the present invention, the method comprises the steps of storing the serious intent rating for a buyer entity on a cookie at a computer of the buyer entity, and updating the serious intent rating on the cookie with a recalculated serious intent rating. The updating may occur periodically, or on a batch basis, or on a real-time or an ad hoc basis after the updating step in block 212. This updating may be facilitated by code in the web content from the system web page present on the buyer entity's browser.

One aspect that is also part of each of the present inventions is the use of the video channel. The term “video channel” is intended to encompass all means of receiving video, including a television, computer screen, handheld device, or other video receiver. Accordingly, the video channel encompasses among other services, interactive television, streaming video, streaming media, cybercasting, video on demand, data conferencing, Internet TV, or other internet based delivery system for providing video over a network

In one example of the video channel, Interactive Television companies have the technology to download and store a plurality of commercials on the personal video recorder (or other similar device) of a viewer or at the server from which the video is streaming or from another site such as a dedicated ad server, and then select which of these commercials to show based on the viewer's preferences. Current business methods for determining the selection of these interactive television advertisements rely on a process of recording and storing information on the viewing habits of these viewers. Information about viewing habits might be supplemented and enhanced on the basis of a viewer's responses to questions that ask him to reveal demographic and other information.

For the reasons outlined above, the selection of advertisements for particular viewing households would be significantly more effective, if the information comprising the viewing habits of the viewers and their answers to some questions could be supplemented with information including the serious intent rating of the buyer entity, or information about the selection of a penalty option or a contingent benefit option.

As noted above, besides interactive television, other examples of the video channel include streaming video, streaming media, cybercasting, video on demand, data conferencing and Internet TV. Some discussion of these examples is set forth below.

Streaming video is a sequence of moving images that are typically sent in compressed form over a data network such as the Internet and displayed by the viewer as they arrive. In some examples of this transmission, the client and server software cooperate for uninterrupted motion. This may be accomplished by way of example but not by way of limitation, by the client side buffering a few seconds of video data before the client starts sending the video data to the screen, which compensates for momentary delays in packet delivery. Streaming media is streaming video with sound. With streaming video or streaming media, a Web user does not have to wait to download a large file before seeing the video or hearing the sound. Instead, the media is sent in a continuous stream and is substantially played as it arrives. The user typically uses a player, which is a special program that uncompresses and sends video data to the display and audio data to speakers. A player can be either an integral part of a browser or can be downloaded from the software maker's Web site. Major current-day streaming video and streaming media technologies include RealSystem G2 from RealNetwork, Microsoft Windows Media Technologies (including its NetShow Services and Theater Server), and VDO. Microsoft's approach uses the standard MPEG compression algorithm for video. The other approaches use proprietary algorithms. Streaming video is usually sent from prerecorded video files, but can be distributed as part of a live broadcast “feed.” In a live broadcast, the video signal is converted into a compressed digital signal and transmitted from a Web server that is able to do multicast, sending the same file to multiple users at the same time.

CyberCasting is web casting on the Internet. Current day packet types in the Internet Protocol Version 6 for web casting include anycast, unicast, and multicast. Although most Internet traffic is unicast (one user requesting files from one source at another Internet address), the Internet's IP protocol supports multicasting, the transmission of data packets intended for multiple addresses. Frequently, MBone is used for cybercasting. The MBone, now sometimes called the Multicast Internet, is an arranged use of a portion of the Internet for Internet Protocol (IP) multicasting (sending files—usually audio and video streams—to multiple users at the same time somewhat as radio and TV programs are broadcast over airwaves).

Video on Demand is the ability to start delivering a movie or other video program to an individual Web browser or TV set whenever the user requests it.

Data Conferencing is the ability of a plurality of users at separate computers to view and interact with the same data or application. Whiteboarding offers the most basic of these capabilities.

Internet TV is an internet service for home or business TV use. A set top box is used to connect a TV to a modem and telephone line. The user interface is typically set up for viewing on an interlaced TV screen rather than a computer monitor.

Note that in many examples of the video channel, such as Interactive television and cybercasting and streaming video, it is much easier for viewers to “zap” through commercials that they do not wish to see. (Zapping means fast forwarding through or otherwise avoiding commercials.) According to preliminary statistics, more than 80 percent of all advertisements that are displayed on interactive television and other examples of the video channel where there is the ability to “zap” an advertisement are “zapped,” e.g., the viewer avails himself/herself of the opportunity and “zaps” the advertisement. As of the date of this application, neither of the two main companies offering interactive television, Tivo and Replay, are compensating viewers with an incentive for watching advertisements. Furthermore, and similarly to the internet, interactive television technology allows the user to interact with advertisements and to buy products or request more information with the use of the remote control.

The use of serious intent ratings and/or the penalty option and/or the contingent benefit option will facilitate better selection and targeting of these advertisements, and could be used to allow video channel viewers to subsidize and pay for the video channel programs that they are watching and the interactive video service they are using.

A buyer entity which participates in the proposed system, could enhance the benefit it receives as described previously through the use of the serious intent rating, the penalty option, and/or the contingent benefit option. This information could be used for the purposes of one or more of the following:

selecting video channel advertisements;

setting a first benefit, which will be the rate at which the viewers are compensated for watching video channel advertisements (presumably, a significantly higher rate than the one they could obtain otherwise); and/or

setting the incentives that are offered within the video channel advertisements themselves.

The process is initiated with a declaration at some point of an intent to purchase by the buyer entity. The serious intent rating of the buyer entity would be accessed or the processing associated with the penalty option or the contingent benefit option would be performed, as described previously. Typically the serious intent rating would be accessed by logging onto the system, or through a local data base or a data base accessed over a network, or from a storage associated with the buyer entity or his/her equipment, e.g., a cookie.

Then this information on the buyer entity's serious intent rating, and/or election of the penalty option, and/or election of the contingent benefit option is used by itself, or in combination with information obtained on existing video channel viewing habits of the buyer entity and demographic information and other pertinent information. This viewing habits/demographic/other information could be accessed from a local data base or from a database accessed over a network or from storage associated with or at the buyer entity's equipment, e.g., a cookie. By way of example but not by way of limitation, an algorithm could be used wherein, for example, the viewing habits/demographic/other information is associated with weights which may then be added to the serious intent rating, or otherwise used as a factor to determine advertisements and/or benefits or some other quantity.

A data base of advertisements is accessed which advertisements are to be played, as well as any serious intent rating thresholds or requirements for an election of the penalty option or contingent benefit option associated with the individual advertisements or sets of advertisements and any rules associated with particular advertisements or sets of advertisements such as playing certain advertisements only with selected programs, or only at certain times of day, or only on certain days, or only for buyer entities with certain demographic characteristics. The advertisements are then selected and may also optionally be sequenced based on these rules, including rules for sequencing based on the serious intent rating value or the fact that an election of the penalty option or the contingent benefit option was elected. For example, information that a buyer entity is a regular viewer of Masterpiece Theater could be used in conjunction with a relatively high serious intent rating in the category of luxury items, as determined for example by comparison of the buyer entity's luxury item serious intent rating to a threshold set for a particular advertisement, to thereby select an advertisement for expensive jewelry, which advertisement will then be placed first in a sequence of advertisements. The demographic information that this buyer entity is in a high income zip code could also be used in conjunction with a high buyer entity serious intent rating in the category of automobiles to then place an advertisement for automobiles second in the sequence of advertisements. This selection and sequence would be determined solely or in combination with other information such as viewing habits and demographic information. The particular sequence rules would be determined as desired.

As noted above, the selection or sequencing of advertisements could be accomplished by comparing one or more of the buyer entity's serious intent ratings or the fact of an election of the penalty option or the contingent benefit option to a set of predetermined thresholds for selected advertisements. Also as noted above, the selection and/or sequencing of advertisements may be determined or rules set to show certain advertisements based in part on the value of the serious intent ratings of the viewer, and in part, on other factors such as the television program that is being watched or the time of day, or the day of the week, or the time of season.

Additionally, the incentive rate at which viewer is compensated for viewing interactive television advertisements may be set, by way of example, using a serious intent rating in an appropriate category or a number of serious intent ratings, or the election of the penalty option or the contingent benefit option as one or more factors and by comparing these buyer entity factors to predetermined thresholds. A wide variety of other factors may be used in combination with the these factors, as noted above, including, by way of example only, the demographics of the buyer entity, the time of day, the day in the week, the time of season, the program being watched.

As noted above, another factor that may be used to select advertisements and set the rate for the provision of benefits is the television program being watched. The advertisement/rate of benefits might differ according to the program that is being watched. This is in order to distinguish between the various members of the household, and to set different reward levels for children and adults. Another way to distinguish between different members of the household is to request entry of a password or code for adult viewers. Entry of the code might also, in one example, allow the viewer to make immediate credit card purchases by remote control, which would discourage parents from giving the code to underage children or other unauthorized individuals.

An algorithm using the foregoing factors could be implemented in a variety of different ways, as is well known to one of ordinary skill in the art, including deriving, by simple addition or a more complex algorithm, a composite advertisement priority value from multiple factor values stored in a lookup table. The lookup table or tables could be set up with different factors used as indexes, so that a subset of the factor values could be easily looked up and used in the algorithm. Alternatively, a variety of different rule based algorithms could be used to derive a sequence of advertisements, as previously discussed.

The advertisements are then shown. In a preferred embodiment, an indication that the advertisement was displayed on the receiver of the buyer entity and was not zapped is obtained. Such an indication may be obtained in a variety of manners from a set top box or other equipment at the buyer entity's receiver. Note that some minimal level of detectable response via remote control might also be required as a condition for crediting the viewer with the reward for watching the advertisement. This is to make sure that the advertisements are indeed being watched and that the television or other video channel is not left on unattended and for the sole purpose of collecting the rewards.

Responses are recorded for processing of the incentive offers. Then the account of the viewer is credited with the reward for viewing advertisements and/or a debit against a program charge, if the program watched had a separate pay TV or other video channel charge associated with it. Additionally, some of the viewed advertisements may be discarded and replaced with new ones, for certain of the video channels. In a preferred embodiment in the pay per view context, the incentive is provided as a reduction or elimination of a pay for view charge for the program that is being watched at the same time as the advertisement. It should be noted that in the context of the contingent benefit option, the charge could be assessed, and then later removed if a proof of purchase is received within the required time period

It should be noted that there are a variety of well known methods available to one of skill in the art to obtain information from the receiver of the buyer entity that is displaying video, for example as discussed, in the context of an interactive video channel such as interactive television. An indication of the channel being viewed may be determined, as well as any action taken (button pushed, for example) by a remote control for that receiver. Note that the response monitoring may be designed to require a buyer entity to respond only intermittently while a plurality of ads are shown for a particular program, e.g., a response would not be required for every ad in a group of ads during a time period in order to receive the incentive. With such a monitoring configuration, the system would provide an incentive credit for all of the ads in a group if a predetermined minimum number of responses is received during a pertinent time period. Alternatively, the system could be set to cancel a credit for all of the ads in a group and provide no credit or a lesser credit if less then the required number of responses is received by the system during a given time period.

As noted above, the information above may be sent back to the system, for determining an ad sequence and/or the selection of ads, and the compensation incentives for viewing those ads. In one embodiment, the recording of this information can be performed at the receiver for the buyer entity and a selection from ads stored at that receiver or at an external server may be made and compensation determined. This compensation and the information on the viewing of the television program may then be held in a storage at an external server, for example, or at a storage on the buyer entity's equipment and/or sent on an ad hoc or periodic basis to the system of the present invention to update the record for that buyer entity and for other purposes.

Accordingly, in yet a further aspect of the present invention, the method comprises monitoring the receipt of video to determine if an ad has been zapped, and providing a benefit to the buyer entity if the ad has not been zapped, with the benefit determined in accordance with the serious intent rating of the buyer entity. It should be noted that the video being monitored can be from any convenient video channel source such as interactive television or streaming video. As noted, an indication of zapping of the ad by the buyer entity can be obtained from the buyer entity's receiver and forwarded over a network to the system for correlation to a benefit.

In a further aspect of the present invention, the method comprises the steps of monitoring the receipt of video at a video channel receiver to determine if an ad has not been zapped, and at some time before or after receipt of the advertisement, determining if the buyer entity has a serious intent rating for a category of the ad, and if so, then determining a benefit based on the serious intent rating in the category if the ad has not been zapped.

In a further aspect of the present invention, the buyer entity is determined in the monitoring the receipt of video step based on the receipt of an ID from the buyer entity.

In a yet further aspect of the present invention, the buyer entity is determined based on a registration of a receiver of the video channel. The identity of the buyer entity is used to determine the appropriate serious intent rating to be used.

In yet a further aspect of the present invention, the receiving a declaration of intent step could comprise monitoring the response of a buyer entity to information provided by the video channel to obtain a declaration of intent to purchase.

In yet a further aspect of the present invention, an interactive video channel system (interactive television or streaming video, for example) could obtain the serious intent rating for an identified buyer entity, and could correlate that serious intent rating to one or more benefits. The interactive video system could obtain the serious intent rating directly from the buyer entity, or via a cookie or other storage on the buyer entity's computer, or if authorized, from the serious intent database 50 directly, or from the system of the present invention. The determination of a benefit step by the interactive video system could also include the step of obtaining other information about the buyer entity, such as demographic information, and using that demographic information in combination with the buyer entity's serious intent rating to determine a benefit to offer to the buyer entity.

In a yet further aspect of any of the embodiments of the present invention, the receiving a declaration of intent step further comprises the steps of asking the buyer entity at least one question relating to the buyer entity's intent; obtaining at least one answer to the at least one question from the buyer entity, and further comprising the step of calculating or adjusting the serious intent rating on the basis of the at least one answer. In this regard, different amounts could be correlated to the different responses available to the buyer entity, which could be added/subtracted or otherwise used to calculate or adjust the serious intent rating for the buyer entity.

In a yet further aspect of the present invention, the calculating or adjusting the serious intent rating step of block 212 further comprises the step of correlating the at least one answer of the buyer entity to the incidence by which members of a comparison group comprising other buyer entities who have given the same or similar answers when making the same or similar declarations of intent have made a purchase conforming with or relating to the declaration of intent; and calculating or adjusting the serious intent rating based on this correlation.

In a yet further aspect of the present invention, the incidence is derived in whole or in part by comparing the number of members of the comparison group who have submitted the proof of purchase with the number of members of the comparison group who have not submitted the proof of purchase.

In a yet further aspect of the present invention, the comparison group comprises only other buyer entities that have submitted declarations of intent to purchase a good or service in a same category as the good or service in the declaration of intent.

In a yet further aspect of the present invention, the members of the comparison group are selected to include members with demographic attributes that are similar to the demographic attributes of the buyer entity.

In a yet further aspect of the present invention, the overall method includes the steps of receiving a proof that the purchase was made in block 210; and adjusting the value of the serious intent rating for the buyer entity based on receipt of proof that the purchase was made in block 212. This aspect of the invention further comprises in the receiving a further declaration of intent step in block 200, receiving a designation of one from a set of levels of intent from the buyer entity; and the determining a benefit step in block 206 comprises selecting at least one benefit based on this designated level of intent. The benefit could be obtained by correlating this level of intent to one or more benefits.

In a yet further aspect of the present invention, the adjusting the value of the serious intent rating step in block 212 comprises adjusting the value of the serious intent rating for the buyer entity based on receipt of the proof that the purchase was made and based on the designated level of intent.

In a yet further aspect of the present invention, the determining a benefit step in block 206 comprises calculating a benefit by applying the serious intent rating as a variable in a mathematical formula.

In a yet further aspect of the present invention, the receiving a declaration of intent step in block 200 comprises receiving a declaration of intent from a buyer entity in which the buyer entity declares its intent to discontinue purchasing a product or service from a selling entity from which it has previously purchased the product or service; and using that intent to discontinue information.

In a yet further aspect of the present invention, the receiving a declaration of intent step in block 200 further comprises receiving from the buyer entity proof of purchase information which indicates the buyer entity's past level of spending on the product or service.

In a yet further aspect of the present invention, the using that intent to discontinue the purchase of a product or service from another selling entity comprises using the intent to discontinue information to determine the at least one benefit.

In a yet further aspect of the present invention, the using step comprises using the intent to discontinue information to recalculate the serious intent rating.

In a yet further aspect of the present invention, the using step comprises designating the buyer entity so that it may be accessed by a search on intent to discontinue declarations in a database such as database 50.

For the embodiment using a serious intent rating for a buyer entity, it can be seen that if the buyer entity purchases a product within the predetermined period of time and submits the proof of purchase in accordance with block 210 within the requisite period of time, then the buyer entity will potentially be credited with a benefit on his/her account, depending on the benefit option that he/she chooses, and his/her serious intent rating will be adjusted upward to reflect the rate at which he has followed through on his/her purchases in block 212. Conversely, if the buyer entity does not purchase the product or service within the predetermined period of time or does not submit the proof of purchase within the predetermined period of time, then his/her account will be debited (alternatively, his/her deposits will be canceled), depending on the benefit/penalty option that was chosen, and his/her serious intent rating will be adjusted downward in block 212.

It is contemplated that in one embodiment of the present invention, that a plurality of buyer entities will elect to have their serious intent ratings made available to advertisers and vendors when they declare their intent to buy a product or service. The serious intent ratings of these buyers would be relayed to advertisers/vendors of the declared products and services, but with the names or other personally identifiable information deleted.

Accordingly, it can be seen that in one embodiment of the present invention, the buyer entity may be asked in an interactive session about the buyer entity's purchase intentions periodically and more comprehensively. As a part of responding to these questions in the interactive session, the buyer entity would be given the option of describing the seriousness and urgency of their purchase intent in greater detail and with great specificity. Buyer entities would be asked how likely they consider a purchase in a particular area and about their sense of urgency. A wide variety of formulas and/or scales may be used to assign proper grading levels to the predictive value of the different declaration of intent announcements by the buyer entity, and the degree to which the actual purchase behavior of a buyer entity demonstrates that he/she generally provides valuable guidance to advertisers/vendors when providing information about his/her purchase intentions in this matter.

Accordingly, it can be seen that the present invention contemplates the use of a declaration of intent to purchase the product or service in conjunction with a variety of different options, some of which includes the use of a serious intent rating. The buyer entity would be motivated to provide proof of purchase information to the system by a desire to increase his/her serious intent rating and to reap the rewards/benefits that come from making a declaration of intent to purchase in the future after having obtained a higher serious intent rating. The buyer entity could also be motivated to provide the proof of purchase to obtain specific benefits. Additionally, the buyer entity could be motivated to provide a proof of purchase based on a penalty alone, or a penalty in conjunction with a benefit. Such a combination would ensure advertisers against the risk that the consumer is not serious about his intent to purchase the product, and would provide the advertisers with a greater incentive to pay the buyer entity to read or view marketing messages and to provide a superior and unusual level of service to selected buyer entities.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen in generally on designer choice. It is understood that all such variations are within the scope of the invention. Likewise, software and web implementation of the present invention could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of a preferred embodiments of the invention has been presented for purposes of illustration and description. It is not intended to be exhaustive nor to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A method for determining a serious intent to purchase a good or service, comprising the steps of:
receiving a declaration of intent to purchase a good or service from a buyer entity and not receiving at substantially the same time a binding commitment to purchase that good or service from a specific selling entity;
receiving a penalty deposit of value or a penalty authorization to obtain something of value from the buyer entity to facilitate future payment of a penalty;
determining if a proof of purchase of said good or service has been received within a predetermined period of time;
if the proof of purchase has been received within the predetermined period of time, then returning the deposit or canceling the authorization.

2. The method as defined in claim 1, further comprising the step of:
providing an exclusive offer to provide at least one benefit to a buyer entity in exchange for engaging in an activity, said activity being associated with learning about the merits of a particular product, manufacturer, brand choice or selling entity associated with the good or service relating to its aforementioned intended purchase, and not making the provision of said benefit or the return of the deposit contingent on the proof of purchase showing a purchase of the particular product or brand or from the particular manufacturer or selling entity.

3. The method as defined in claim 2, further comprising the step of providing the at least one benefit to the buyer entity prior to receipt of the proof of purchase.

4. The method as defined in claim 2, wherein said good or service is determined to be in a category; and
wherein said providing an offer with a benefit step comprises selecting at least one benefit that is correlated to the category of good or service.

5. The method as defined in claim 2, further comprising the step of providing the benefit to the buyer entity only if the proof of purchase has been received.

6. The method as defined in claim 2, wherein said good or service is determined to be in a category; and
wherein said providing an offer with a benefit step comprises selecting at least one benefit that is correlated to the category of good or service.

7. The method as defined in claim 1, wherein said receiving proof of purchase step comprises linking to a third party database and obtaining information there from on whether the buyer entity made a purchase of the good or service in the declaration.

8. The method as defined in claim 1, wherein said proof that the purchase was made comprises receiving proof of purchase records created by a third party source; and further comprising the step of comparing the third party source of the proof of purchase records with a source database of third party sources and entering only those proof of purchase records if from third party sources that are in the source database.

9. The method as defined in claim 2, wherein the providing at least one benefit step comprises the steps of sending a communication including a serious intent rating to a third party; and receiving an identification of the at least one benefit from the third party.

10. The method as defined in claim 2, wherein said providing said at least one benefit step comprises directly providing the at least one benefit to the buyer entity.

11. The method as defined in claim 2, wherein the facilitating the provision of said at least one benefit step comprises sending a third party a communication to initiate the provision of the benefit by the third party.

12. The method as defined in claim 1, further comprising searching a database to obtain a serious intent rating for the buyer entity.

13. The method as defined in claim 2, wherein the benefit and penalty comprise crediting and/or debiting an account.

14. The method as defined in claim 2, wherein the providing an offer to provide at least one benefit step comprises the steps of:
obtaining at least one threshold serious intent rating for the intended purchase;
comparing the threshold serious intent rating to a serious intent ratings of the buyer entity; and
selecting the at least one benefit based on a result of the comparison.

15. The method as defined in claim 1, further comprising the step of:
obtaining at least one threshold serious intent rating for the intended purchase to be made by the buyer entity as well as a serious intent rating for the buyer entity;
comparing the threshold serious intent rating to the serious intent rating of the buyer entity; and
selecting penalty based on a result of this comparison.

16. The method as defined in claim 2, wherein the benefit comprises a set of benefits, with at least one of the set of benefits having a reward associated with its selection that is to be paid to the buyer entity.

17. The method as defined in claim 2, further comprising the step of:
obtaining a serious intent rating for the buyer entity; and
generating a charge to an advertiser providing the at least one benefit as a function of the serious intent rating of the buyer entity receiving the benefit.

18. The method as defined in claim 2, further comprising the steps of:
determining an income level for the buyer entity;
comparing the income level of the buyer entity to a threshold income level and only offering at least one of the benefits if the buyer entity income level exceeds the threshold income level.

19. The method as defined in claim 2, wherein the receiving a declaration of intent step comprises receiving a designation of one from a set of levels of intent from the buyer entity; and
further comprising the step of determining the benefit by selecting at least one benefit based on this designated level of intent.

20. The method as defined in claim 2, further comprising the step of calculating a serious intent rating of a buyer entity based on the factors of the number of times the buyer entity has declared that it would purchase a product or service, and the number of times that proof that the product or service was purchased was received for the buyer entity within a predetermined time period; and using that serious intent rating to select at least one benefit to be offered to the buyer entity.

21. The method as defined in claim 20, wherein the step of calculating the serious intent rating of a buyer entity also includes as part of the calculation the factors of the total amount of money that the buyer entity has spent for the product or service over a predetermined time period, and the total amount of money for the products and/or services that the buyer entity has declared a serious intent to purchase.

22. The method as defined in claim 21, wherein the serious intent rating is partly calculated by multiplying the number of times the buyer entity has declared that it will purchase a product or service by the percentage of times that the proof of purchase for the buyer entity related to the declaration of serious intent has been submitted within the predetermined time period, and partly calculated by multiplying the total amount of money spent in relation to serious intent declarations by the total amount of money for the product and/or services for which the buyer entity has made serious intent declarations.

23. The method as defined in claim 2, further comprising the steps of:
determining a category for the goods or services designated in the intent to purchase from a set of categories;
wherein said obtaining a serious intent rating step comprises determining a serious intent rating for the buyer entity in the determined category of goods or services; and
selecting benefits from different vendors selling the designated goods or services in the determined category.

24. The method as defined in claim 23, further comprising the step of calculating a class serious intent rating for a particular buyer entity in accordance with a function of separate serious intent ratings of a plurality of selected categories for the particular buyer entity; and
wherein said providing at least one benefit step comprises selecting one benefit based on said class serious intent rating.

25. The method as defined in claim 2, further comprising the steps of:
receiving buyer entity preferences for particular benefits;
wherein said providing an offer to provide at least one benefit step comprises selecting a group of benefits for presentation to the buyer entity, based at least in part, on said buyer entity preferences.

26. The method as defined in claim 2, further comprising the steps of:
receiving a threshold value from the buyer entity that the benefits must meet before the buyer entity will receive the benefit; and
wherein the providing an offer step comprises providing only benefits that meet or exceed said threshold value.

27. The method as defined in claim 26, wherein the providing an offer step comprises providing a plurality of said benefits from different advertisers to the buyer entity, including the step of determining the sequence or the relative prominence of each of the plurality of the benefits based on said serious intent rating.

28. The method as defined in claim 2, further comprising:
obtaining non-purchase information about the buyer entity from a third party; and
searching the non-purchase information to obtain at least one attribute about the buyer entity;
correlating that attribute to a benefit from among a plurality of benefits based on said correlated attribute; and
wherein the providing an offer to provide at least one benefit step comprises presenting or facilitating the presentation of said correlated benefit to said buyer entity.

29. The method as defined in claim 2, wherein said providing an offer of at least one benefit step further comprises the step of selecting one of the benefits based on a serious intent rating of the buyer entity; and further comprising sending the serious intent rating of the buyer entity to a third party after receipt of an authorization from said buyer entity.

30. The method as defined in claim 2, wherein said providing an offer of at least one benefit step further comprises the step of selecting one of the benefits based on a serious intent rating of the buyer entity; and further comprising storing electronically the serious intent rating for the buyer entity at a computer of said buyer entity.

31. The method as defined in claim 30, wherein said storing step comprises storing the serious intent rating on a cookie.

32. The method as defined in claim 30, further comprising the step of said buyer entity sending said serious intent rating to a third party.

33. The method as defined in claim 2, wherein said providing an offer of at least one benefit step further comprises the step of selecting one of the benefits based on a serious intent rating of the buyer entity, wherein the selecting step includes comparing the serious intent rating of the buyer entity to a set of threshold levels, with a different predetermined benefit associated with exceeding each different threshold level in said set of threshold levels; and
selecting the benefit associated with the highest threshold level exceeded by the serious intent rating.

34. The method as defined in claim 1, wherein said determining if a proof of purchase has been received step comprises linking to a third party database and obtaining information there from on whether the buyer entity made a purchase of the good or services in the declaration and inputting this information to a database.

35. The method as defined in claim 1, wherein said determining if a proof of purchase has been received step comprises receiving proof of purchase records created by a third party source; and further comprising the step of comparing the third party source of the proof of purchase records with a source database of third party sources and entering only those proof of purchase records if from third party sources that are in the source database.

36. The method as defined in claim 2, wherein said providing an offer of at least one benefit step further comprises the step of selecting one of the benefits based on a serious intent rating of the buyer entity; and further comprising the steps of:
storing the serious intent rating for the buyer entity on a cookie at a computer of said buyer entity;
a merchant accessing said cookie and obtaining said serious intent rating;
said merchant correlating said accessed serious intent rating to at least one item of content; and
serving to the buyer entity said at least one item of content.

37. The method as defined in claim 2, wherein said providing an offer of at least one benefit step further comprises the step of selecting one of the benefits based on a serious intent rating of the buyer entity; and further comprising the steps of storing the serious intent rating for a buyer entity on a cookie at a computer of said buyer entity; and updating the serious intent rating on said cookie with a recalculated serious intent rating.

38. The method as defined in claim 1, further comprising monitoring the receipt of video to determine if an ad has been zapped; and providing a benefit to the buyer entity if the ad has not been zapped.

39. The method as defined in claim 1, further comprising the steps of:
monitoring the receipt of video to determine if an ad has not been zapped;
if the ad has not been zapped, then determining a benefit to be offered to the buyer entity based on a serious intent rating of the buyer entity.

40. The method as defined in claim 39, wherein said buyer entity is determined based on receipt of an ID from the buyer entity.

41. The method as defined in claim 39, wherein the buyer entity is determined based on a registration of a receiver for the video.

42. The method as defined in claim 1, wherein the receiving a declaration of intent step further comprises, asking the buyer entity at least one question relating to the buyer entity's intent;
obtaining at least one answer to said at least one question from the buyer entity;
and further comprising
calculating or adjusting a serious intent rating on the basis of said at least one answer; and
using the serious intent rating to select benefits to be offered to the buyer entity.

43. The method as defined in claim 42, wherein the calculating or adjusting the serious intent rating step further comprises, correlating the at least one answer of the buyer entity to the incidence by which members of a comparison group comprising other buyer entities who have given the same or similar answer relative to the at least one answer when making the same or a similar declaration of intent have made a purchase conforming with or relating to said declaration of intent; and calculating or adjusting the serious intent rating based on said correlation.

44. The method as defined in claim 42, wherein said incidence is derived in whole or in part by comparing the number of members of said comparison group who have submitted said proof of purchase with the number of members of said comparison group who have not submitted said proof of purchase.

45. The method as defined in claim 42, wherein said comparison group comprises only other buyer entities that have submitted declarations of intent to purchase a good or service in a same category as the good or service in said declaration of intent.

46. The method as defined in claim 42, wherein members of said comparison group are selected to include members with demographic attributes that are similar to the demographic attributes of said buyer entity.

47. The method as defined in claim 2, further comprising:
adjusting a value of the serious intent rating for said buyer entity based on receipt of said proof that the purchase was made; and
wherein the receiving a declaration of intent step comprises receiving a designation of one from a set of levels of intent from the buyer entity; and
wherein the providing an offer step to provide at least one benefit step comprises selecting at least one benefit based on this designated level of intent.

48. The method as defined in claim 47, wherein the adjusting the value of the serious intent rating step comprises also adjusting said value of the serious intent rating for the buyer entity based on said designated level of intent.

49. The method as defined in claim 52, wherein said providing an offer of at least one benefit step further comprises the step of selecting one of the benefits based on a serious intent rating of the buyer entity, wherein the serious intent rating is used as a variable in a mathematical formula to calculate the benefit.

50. The method as defined in claim 1, wherein the receiving a declaration of intent step comprises receiving a declaration of intent from a buyer entity in which the buyer entity declares its intent to discontinue purchasing a product or service from a selling entity from which it has previously purchased said product or service; and using that intent to discontinue information.

51. The method as defined in claim 50, wherein the receiving a declaration of intent step further comprises receiving from a buyer entity proof of purchase information which indicates the buyer entity's past level of spending on said product or service.

52. The method as defined in claim 50, wherein said using step comprises using the intent to discontinue information to determine the at least one benefit.

53. The method as defined in claim 50, further comprising the step of providing an offer of at least one benefit by selecting the benefit based on a serious intent rating of the buyer entity; and wherein said using step comprises using the intent to discontinue information to recalculate the serious intent rating.

54. The method as defined in claim 50, wherein said using step comprises designating the buyer entity so that it may be accessed by a search on intent to discontinue declarations.

55. The method as defined in claim 2, wherein said receiving a declaration of intent step comprises receiving a declaration of intent from a buyer entity in which it declares its intent to discontinue purchasing a product or service from a first selling entity from which it has previously purchased said product or service on a regular basis; and
wherein said returning the deposit or canceling the authorization step is contingent upon said proof of purchase showing that said buyer entity has purchased said product or service from a second selling entity which is different from the first selling entity after submitting its declaration of intent.

56. The method as defined in claim 1, wherein the receiving a declaration of intent step further comprises receiving a proof of purchase from a buyer entity which indicates its past level of spending on said product or service.

57. The method as defined in claim 1, wherein said receiving a declaration of intent step contains a declaration of said buyer entity's intent or willingness to make a plurality of purchases exceeding in the aggregate at least a specified volume of a product or service or of a category of products or services from a single selling entity over a specified time period, and
wherein said determining if a proof of purchase has been received comprises receiving a proof that an amount equal or higher then said specified volume was purchased by said buyer entity over said specified time period.

58. A system for determining a serious intent to purchase a good or service, comprising:
a component for receiving a declaration of intent to purchase a good or service from a buyer entity and not receiving at substantially the same time a commitment to purchase that good or service from a specific selling entity;
a component for receiving a penalty deposit of value or a penalty authorization to obtain something of value from the buyer entity to facilitate future payment of a penalty;
a component for determining if a proof of purchase of said good or service has been received within a predetermined period of time;
a component for, if the proof of purchase has been received within the predetermined period of time, returning the deposit or canceling the authorization.

59. The system as defined in claim 58, further comprising:
a component for providing an offer to provide at least one benefit to a buyer entity relating to its aforementioned intended purchase.

60. The system as defined in claim 59, further comprising a component for providing the at least one benefit to the buyer entity prior to receipt of the proof of purchase.

61. The system as defined in claim 59, wherein said good or service is determined to be in a category; and
wherein said component for providing an offer with a benefit comprises a component for selecting at least one benefit that is correlated to the category of good or service.

62. The system as defined in claim 59, further comprising a component for providing the benefit to the buyer entity only if the proof of purchase has been received.

63. The system as defined in claim 59, wherein said good or service is determined to be in a category; and
wherein said component for providing an offer with a benefit comprises a component for selecting at least one benefit that is correlated to the category of good or service.

64. The system as defined in claim 58, wherein said component for receiving proof of purchase comprises a component for linking to a third party database and obtaining information therefrom on whether the buyer entity made a purchase of the good or service in the declaration.

65. The system as defined in claim 58, wherein said proof that the purchase was made comprises receiving proof of purchase records created by a third party source; and further comprising a component for comparing the third party source of the proof of purchase records with a source database of third party sources and entering only those proof of purchase records if from third party sources that are in the source database.

66. The system as defined in claim 59, wherein the component for providing at least one benefit comprises a component for sending a communication including a serious intent rating to a third party; and receiving an identification of the at least one benefit from the third party.

67. The system as defined in claim 59, wherein said component for providing said at least one benefit comprises a component for directly providing the at least one benefit to the buyer entity.

68. The system as defined in claim 59, wherein the component for providing the offer of at least one benefit comprises a component for sending a third party a communication to initiate the provision of the benefit by the third party.

69. The system as defined in claim 58, further comprising a component for searching a database to obtain a serious intent rating for the buyer entity.

70. The system as defined in claim 59, wherein the benefit and penalty comprise crediting and/or debiting an account.

71. The system as defined in claim 59, wherein the component for providing an offer to provide at least one benefit comprises:
a component for obtaining at least one threshold serious intent rating for the intended purchase;
a component for comparing the threshold serious intent rating to a serious intent ratings of the buyer entity; and
a component for selecting the at least one benefit based on a result of the comparison.

72. The system as defined in claim 58, further comprising
a component for obtaining at least one threshold serious intent rating for the intended purchase to be made by the buyer entity as well as a serious intent rating for the buyer entity;
a component for comparing the threshold serious intent rating to the serious intent rating of the buyer entity; and
a component for selecting the penalty based on a result of this comparison.

73. The system as defined in claim 59, wherein the benefit comprises a set of benefits, with at least one of the set of benefits having a reward associated with its selection that is to be paid to the buyer entity.

74. The system as defined in claim 59, further comprising a component for obtaining a serious intent rating for the buyer entity; and
a component for generating a charge to an advertiser providing the at least one benefit as a function of the serious intent rating of the buyer entity receiving the benefit.

75. The system as defined in claim 59, further comprising:
a component for determining an income level for the buyer entity;
a component for comparing the income level of the buyer entity to a threshold income level and only offering at least one of the benefits if the buyer entity income level exceeds the threshold income level.

76. The system as defined in claim 59, wherein the component for receiving a declaration of intent comprises a component for receiving a designation of one from a set of levels of intent from the buyer entity; and
further comprising a component for determining the benefit by selecting at least one benefit based on this designated level of intent.

77. The system as defined in claim 59, further comprising a component for calculating a serious intent rating of a buyer entity based on the factors of the number of times the buyer entity has declared that it would purchase a product or service, and the number of times that proof that the product or service was purchased was received for the buyer entity within a predetermined time period; and using that serious intent rating to select at least one benefit to be offered to the buyer entity.

78. The system as defined in claim 77, wherein the component for calculating the serious intent rating of a buyer entity also includes as part of the calculation the factors of the total amount of money that the buyer entity has spent for the product or service over a predetermined time period, and the total amount of money for the products and/or services that the buyer entity has declared a serious intent to purchase.

79. The system as defined in claim 78, wherein the serious intent rating is partly calculated by multiplying the number of times the buyer entity has declared that it will purchase a product or service by the percentage of times that the proof of purchase for the buyer entity related to the declaration of serious intent has been submitted within the predetermined time period, and partly calculated by multiplying the total amount of money spent in relation to serious intent declarations by the total amount of money for the product and/or services for which the buyer entity has made serious intent declarations.

80. The system as defined in claim 59, further comprising:
a component for determining a category for the goods or services designated in the intent to purchase from a set of categories;
wherein said component for obtaining a serious intent rating comprises a component for determining a serious intent rating for the buyer entity in the determined category of goods or services; and
a component for selecting benefits from different vendors selling the designated goods or services in the determined category.

81. The system as defined in claim 80, further comprising a component for calculating a class serious intent rating for a particular buyer entity in accordance with a function of separate serious intent ratings of a plurality of selected categories for the particular buyer entity; and
wherein said component for providing an offer of at least one benefit comprises a component for selecting one benefit based on said class serious intent rating.

82. The system as defined in claim 59, further comprising: a component for receiving buyer entity preferences for particular benefits;
wherein said component for providing an offer to provide at least one benefit comprises a component for selecting a group of benefits for presentation to the buyer entity, based at least in part, on said buyer entity preferences.

83. The system as defined in claim 59, further comprising:
a component for receiving a threshold value from the buyer entity that the benefits must meet before the buyer entity will receive the benefit; and
wherein the component for providing an offer comprises a component for providing only benefits that meet or exceed said threshold value.

84. The system as defined in claim 83, wherein the component for providing an offer comprises a component for providing a plurality of said benefits from different advertisers to the buyer entity, and determining the sequence or the relative prominence of each of the plurality of the benefits based on said serious intent rating.

85. The system as defined in claim 59, further comprising:
a component for obtaining non-purchase information about the buyer entity from a third party;
a component for searching the non-purchase information to obtain at least one attribute about the buyer entity;
a component for correlating that attribute to a benefit from among a plurality of benefits based on said correlated attribute; and
wherein the component for providing an offer to provide at least one benefit comprises a component for presenting or facilitating the presentation of said correlated benefit to said buyer entity.

86. The system as defined in claim 59, wherein said component for providing an offer of at least one benefit further comprises a component for selecting one of the benefits based on a serious intent rating of the buyer entity; and further comprising a component for sending the serious intent rating of the buyer entity to a third party after receipt of an authorization from said buyer entity.

87. The system as defined in claim 59, wherein said component for providing an offer of at least one benefit further comprises a component for selecting one of the benefits based on a serious intent rating of the buyer entity; and further comprising a component for storing electronically the serious intent rating for the buyer entity at a computer of said buyer entity.

88. The system as defined in claim 87, wherein said component for storing comprises a component for storing the serious intent rating on a cookie.

89. The system as defined in claim 87, further comprising a component for allowing the buyer entity to send said serious intent rating to a third party.

90. The system as defined in claim 59, wherein said component for providing an offer of at least one benefit further comprises a component for selecting one of the benefits based on a serious intent rating of the buyer entity, wherein the component for selecting includes a component for comparing the serious intent rating of the buyer entity to a set of threshold levels, with a different predetermined benefit associated with exceeding each different threshold level in said set of threshold levels; and
a component for selecting the benefit associated with the highest threshold level exceeded by the serious intent rating.

91. The system as defined in claim 58, wherein said component for determining if a proof of purchase has been received comprises a component for linking to a third party database and obtaining information therefrom on whether the buyer entity made a purchase of the good or services in the declaration and inputting this information to a database.

92. The system as defined in claim 58, wherein said component for determining if a proof of purchase has been received comprises a component for receiving proof of purchase records created by a third party source; and further comprising a component for comparing the third party source of the proof of purchase records with a source database of third party sources and entering only those proof of purchase records if from third party sources that are in the source database.

93. The system as defined in claim 59, wherein said component for providing an offer of at least one benefit further comprises a component for selecting one of the benefits based on a serious intent rating of the buyer entity; and further comprising:
a component for storing the serious intent rating for the buyer entity on a cookie at a computer of said buyer entity;
a component for allowing a merchant to access said cookie and obtain said serious intent rating;
said merchant correlating said accessed serious intent rating to at least one item of content; and
a component for serving to the buyer entity said at least one item of content.

94. The system as defined in claim 59, wherein said component for providing an offer of at least one benefit further comprises a component for selecting one of the benefits based on a serious intent rating of the buyer entity; and further comprising a component for storing the serious intent rating for a buyer entity on a cookie at a computer of said buyer entity; and a component for updating the serious intent rating on said cookie with a recalculated serious intent rating.

95. The system as defined in claim 58, further comprising a component for monitoring the receipt of video to determine if an ad has been zapped; and providing a benefit to the buyer entity if the ad has not been zapped.

96. The system as defined in claim 58, further comprising:
a component for monitoring the receipt of video to determine if an ad has not been zapped; and
a component for determining a benefit to be offered to the buyer entity based on a serious intent rating of the buyer entity if the ad has not been zapped.

97. The system as defined in claim 96, wherein said buyer entity is determined based on receipt of an ID from the buyer entity.

98. The system as defined in claim 96, wherein the buyer entity is determined based on a registration of a receiver for the video.

99. The system as defined in claim 59, wherein the component for receiving a declaration of intent further comprises, a component for asking the buyer entity at least one question relating to the buyer entity's intent;
a component for obtaining at least one answer to said at least one question from the buyer entity;
and further comprising
a component for calculating or adjusting a serious intent rating on the basis of said at least one answer; and
a component for using the serious intent rating to select benefits to be offered to the buyer entity.

100. The system as defined in claim 99, wherein the component for calculating or adjusting the serious intent rating further comprises, a component for correlating the at least one answer of the buyer entity to the incidence by which members of a comparison group comprising other buyer entities who have given the same or similar answer relative to the at least one answer when making the same or a similar declaration of intent have made a purchase conforming with or relating to said declaration of intent; and calculating or adjusting the serious intent rating based on said correlation.

101. The system as defined in claim 100, wherein said incidence is derived in whole or in part by comparing the number of members of said comparison group who have submitted said proof of purchase with the number of members of said comparison group who have not submitted said proof of purchase.

102. The system as defined in claim 100, wherein said comparison group comprises only other buyer entities that have submitted declarations of intent to purchase a good or service in a same category as the good or service in said declaration of intent.

103. The system as defined in claim 100, wherein members of said comparison group are selected to include members with demographic attributes that are similar to the demographic attributes of said buyer entity.

104. The system as defined in claim 59, further comprising:
a component for adjusting a value of the serious intent rating for said buyer entity based on receipt of said proof that the purchase was made; and
wherein the component for receiving a declaration of intent comprises receiving a designation of one from a set of levels of intent from the buyer entity; and
wherein the component for providing an offer to provide at least one benefit step comprises a component for selecting at least one benefit based on this designated level of intent.

105. The system as defined in claim 104, wherein the component for adjusting the value of the serious intent rating comprises a component for also adjusting said value of the serious intent rating for the buyer entity based on said designated level of intent.

106. The system as defined in claim 59, wherein said component for providing an offer of at least one benefit further comprises a component for selecting one of the benefits based on a serious intent rating of the buyer entity, wherein the serious intent rating is used as a variable in a mathematical formula to calculate the benefit.

107. The system as defined in claim 58, wherein the component for receiving a declaration of intent comprises a component for receiving a declaration of intent from a buyer entity in which the buyer entity declares its intent to discontinue purchasing a product or service from a selling entity from which it has previously purchased said product or service; and a component for using that intent to discontinue information.

108. The system as defined in claim 107, wherein the component for receiving a declaration of intent further comprises a component for receiving from a buyer entity proof of purchase information which indicates the buyer entity's past level of spending on said product or service.

109. The system as defined in claim 107, wherein said component for using comprises a component for using the intent to discontinue information to determine the at least one benefit.

110. The system as defined in claim 107, further comprising a component for providing an offer of at least one benefit by selecting the benefit based on a serious intent rating of the buyer entity; and wherein said component for using comprises a component for using the intent to discontinue information to recalculate the serious intent rating.

111. The system as defined in claim 107, wherein said component for using comprises a component for designating the buyer entity so that it may be accessed by a search on intent to discontinue declarations.

112. The system as defined in claim 59, wherein said component for receiving a declaration of intent comprises a component for receiving a declaration of intent from a buyer entity in which it declares its intent to discontinue purchasing a product or service from a first selling entity from which it has previously purchased said product or service on a regular basis; and
wherein said component for returning the deposit or canceling the authorization is contingent upon said proof of purchase showing that said buyer entity has purchased said product or service from a second selling entity which is different from the first selling entity after submitting its declaration of intent.

113. The system as defined in claim 58, wherein the component for receiving a declaration of intent further comprises a component for receiving a proof of purchase from a buyer entity which indicates its past level of spending on said product or service.

114. The system as defined in claim 58, wherein said component for receiving a declaration of intent detects a declaration of said buyer entity's intent or willingness to purchase at least a specified volume of a product or service or of a category of products or services from a single selling entity over a specified time period, and
wherein said component for determining if a proof of purchase has been received comprises a component for receiving a proof that an amount equal or higher then said specified volume was purchased by said buyer entity over said specified time period.
